(19) United States
(12) Patent Application Publication
(10) Pub. No.: US 2011/0163041 A1
(43) Pub. Date: Jul. 7, 2011

(54) METHOD FOR CONTROLLING THE DISTURBANCE OF NETWORKED PULP

(75) Inventors: Ian Arbuthnot, Halls Head (AU); Richard Triglavcanin, Dalkeith (AU)

(73) Assignee: OUTOTEC OYJ, Espoo (FI)

(21) Appl. No.: 13/063,744

(22) PCT Filed: Sep. 16, 2009
(86) PCT No.: PCT/AU2009/001225

§ 371 Date: Mar. 11, 2011

(30) Foreign Application Priority Data
Sep. 17, 2008 (AU) 2008904843

(51) Int. Cl. B01D 21/06; B01D 21/01; B01D 21/32

(52) U.S. Cl. 210/709; 210/740; 210/97

(57) ABSTRACT

The invention provides a method (20) for controlling a disturbance (15) to networked pulp in a separation device comprising a tank (1), the method (20) comprising the steps of introducing a feed material into the tank at a flux (21); allowing pulp to settle out of the feed material and form into a networked layer of pulp (22); disturbing the networked pulp in a disturbance zone (16) of the networked layer (23); and controlling one or more disturbance parameters with respect to the flux and/or one or more operational parameters to controllably apply an optimal disturbance to the networked pulp in the disturbance zone (31). The invention also provides a separation device for separating pulp from a feed material.

### FIELD OF THE INVENTION

The present invention relates to separation devices for suspensions and pulps and in particular to a method for controlling the disturbance of networked pulp in a separation device. It has been developed primarily for use in thickeners and will be described hereinafter with reference to this application. However, it will be appreciated that the invention is not limited to this particular field of use.

### BACKGROUND OF THE INVENTION

The following discussion of the prior art is intended to present the invention in an appropriate technical context and allow its significance to be properly appreciated. Unless clearly indicated to the contrary, however, reference to any prior art in this specification should not be construed as an admission that such art is widely known or forms part of common general knowledge in the field.

Separation devices, such as thickeners, clarifiers and concentrators, are typically used for separating solids from suspensions (typically containing solids suspended in a liquid) and are often found in the mining, mineral processing, food processing, sugar refining, water treatment, sewage treatment, and other such industries. These devices typically comprise a tank in which solids are deposited from a suspension or solution and settle toward the bottom as pulp or sludge to be drawn off from below and recovered. A dilute liquor of lower relative density is thereby displaced toward the top of the tank, for removal via an overflow launder. The suspension to be thickened is initially fed through a feed pipe, conduit or line into a feedwell disposed within the main tank. A rake assembly is conventionally mounted for rotation about a central drive shaft and typically has at least two rake arms having scraper blades to move the settled material inwardly for collection through an underflow outlet.

In its application to mineral processing, separation and extraction, a finely ground ore is suspended as pulp in a suitable liquid medium such as water at a consistency which permits flow, and settlement in quiescent conditions. The pulp is settled from the suspension by a combination of gravity with or without chemical and/or mechanical processes. Initially, coagulant and/or flocculant can be added into the suspension to improve the settling process. The suspension is then carefully mixed into the separation device, such as a thickener, to facilitate the clumping together of solid particles, eventually forming larger denser “aggregates” of pulp particles that are settled out of suspension. Liquid, also known as liquor, is typically trapped with the solid particles within the pulp aggregates

Typically, several zones or layers of material having different overall densities gradually form within the tank, as illustrated in FIG. 1A. At the bottom of the tank 1, the pulp forms a relatively dense zone 2 of compacted pulp or solids 3 that are frequently in the form of networked aggregates (i.e. the pulp aggregates are in continuous contact with one another). This zone 2 is typically called a “pulp bed” or a networked layer of pulp. Above the pulp bed 2, a hindered zone 4 tends to contain solids 5 that have not yet fully settled or “compacted”. That is, the solids or aggregates 5 are not yet in continuous contact with one another (un-networked). Above the hindered zone 4 is a “free settling” zone 6, where solids or aggregates 7 are partially suspended in the liquid and descending toward the bottom of the tank 1. It will be appreciated that the hindered zone 4 is not always a distinct zone between the networked layer 2 and the free settling zone 6. Instead, the hindered zone 4 may form a transition or an interface between the networked layer 2 and the free settling zone 6 that blends between the two zones. Above the free settling zone 6 is a clarified zone 8 of dilute liquor, where little solids are present and the dilute liquor is removed from the tank 1 by way of an overflow launder (not shown). FIG. 1A also illustrates the feedwell 9 and underflow outlet 10 for removing the compacted pulp 3 from the tank 1.

It has hitherto been conventionally thought that to ensure that an appropriate underflow density is maintained within the pulp bed 2, it and the hindered zone 4 should be undisturbed to permit settling of the dense aggregates of solid particles into their desirable compacted arrangement. As a consequence, most developments in separation device technology concern the improvement of the settling process, either in the feedwell or the free settling zone 6, rather than any processes which may disturb the compacted arrangement of the solids particles in the pulp bed 3 or the partially compacted solids in the hindered zone 4.

It has also been found that as the pulp bed 2 increases in depth, it becomes increasingly difficult for released liquid to permeate through the pulp bed 2 and migrate upwardly into the clarified zone 8. One solution has been to provide dewatering pickets mounted to the rake arms to aid removal of such liquid, thereby increasing the underflow density and thus the efficiency of the separation process. These pickets are typically arranged at equally spaced intervals to produce dewatering channels in the pulp bed equally spaced across the diameter of the tank, and are designed to minimise disturbance of the pulp bed.

It has also been found that the rotation of the rake assembly, with or without pickets, increases the possibility of pulp bed rotation, which is also known as “donutting”. Donutting occurs where discrete agglomerated masses of pulp particles, referred to as “donuts” or “islands”, form around the rake assembly, causing an increase in the torque required to rotate the rake assembly and a decreased active cross-sectional area for separation. Hence, this results in a decrease in the density of the thickened pulp. In the case of a rake assembly, the agglomerated masses tend to accumulate around the rake arms and pickets, and thus tend to rotate with the rotation of the rake assembly. In donutting, the whole of the thickened pulp bed does not necessarily rotate when an agglomerated mass forms, nor does the rest of the contents of the thickening tank—only the agglomerated mass actually rotates. As a consequence, this phenomenon detrimentally affects thickener performance and efficiency in three primary ways. Firstly, the accumulation of agglomerated masses around the rake assembly impedes the formation of the desired bed of relatively uniform thickened pulp and decreases the active cross-sectional areas for separation, thus reducing the pulp density, or underflow density. Secondly, the increased torque that is required to rotate the rake assembly increases the wear on the drive assembly, thus increasing the frequency of maintenance and hence downtime for the thickener. Thirdly, donutting prevents the rake assembly from performing its primary function of raking the settled solids to the central discharge point.

Various solutions have been proposed for inhibiting or preventing donutting. One proposed solution has been the placement of stationary baffles or pickets to prevent the formation of agglomerated masses by breaking up any such formations around the rake assembly.

It is an object of the invention to overcome or ameliorate one or more of the deficiencies of the prior art, or at least to provide a useful alternative.

### SUMMARY OF THE INVENTION

The inventors have discovered unexpectedly and surprisingly that the application of a disturbance, preferably in the form of shear to pulp can result in improved efficiency in the separation process, especially the settling process in a thickener. It is believed that causing a disturbance substantially uniformly across a disturbance zone in a region, especially an upper region of the networked layer of pulp, results in at least a proportion of the networked pulp being disrupted, either by breaking up, disturbing, re-arranging, re-orienting or “shaking” the continuous contact between the pulp, or subjecting it to a force. This disruption of the networked pulp enables the release of trapped liquid upwardly towards the clarified zone of dilute liquor and increases the density of the pulp below the disturbance zone relative to pulp density above the disturbance zone. At the same time, the disturbance creates turbulence that inhibits or prevents the formation of donuts in the pulp bed. Moreover, the inventors have determined that if the disturbance is too much, fractionation of the networked pulp into smaller pieces occurs, resulting in the smaller pieces settling more slowly. Too little disturbance fails to disrupt the networked pulp sufficiently to release enough liquid to improve settling efficiency. Thus, the inventors have determined that by controlling the amount of the disturbance to an optimum level, as distinct from a minimum level, the improved separation efficiency can be maintained continuously over the work cycles of the separation device.

Throughout the description and claims, the terms “disrupt”, “disrupting”, “disruption” and its variants are taken to mean breaking up, disturbing, re-arranging, re-orienting or “shaking” particles or a substance, as well as applying a force to the particles or substance. In the context of the present invention, these terms are taken to mean breaking up, disturbing, re-arranging, re-orienting, applying a force to, or “shaking” the organised structure of the networked pulp, including but not limited to the continuous contact between the networked pulp.

Accordingly, a first aspect of the invention provides a method for controlling a disturbance to networked pulp in a separation device comprising a tank, the method comprising the steps of:

introducing a feed material into the tank at a flux;

allowing pulp to settle out of the feed material and form into a networked layer of pulp;

disturbing the networked pulp in a disturbance zone of the networked layer; and

controlling one or more disturbance parameters with respect to the flux and/or one or more operational parameters to controllably apply an optimal disturbance to the networked pulp in the disturbance zone.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Throughout the description and claims, the term “flux” means the rate of flow of solids suspended in a fluid (generally a liquid) suspension and is measured in tonnes per square metre hour (t/m²h). In the context of minerals separation, the flux is used to refer to the flow of suspended pulp solids in the slurry. Although the solids concentration or pulp density of the suspension may change as the pulp moves through the tank, the flow of solids may be regarded as independent of the pulp density and so is expressed as a flux.

Preferably, the method comprises the step of adjusting one or more of the disturbance parameters in response to changes in the flux.

Preferably, the disturbance parameters are selected from the group consisting essentially of the frequency of the disturbance events in the disturbance zone and the depth of the disturbance zone.

Preferably, one or more of the disturbance parameters are controlled according to the relationship:

S₀=z.f₁(h).f₂(f).f₃(ρ)

where
S₀ is the optimal disturbance;
z is the frequency, or number of passes, of disturbance events in the disturbance zone within the predetermined period of time;
f₁(h) is the disturbance zone height or depth function;
f₂(f) is the flux function; and
f₃(ρ) is the operational parameter function.

The operational parameter function f₃(ρ) represents the one or more variable operational parameters of the separation device. Where a particular operational parameter is constant (or is assumed to be constant), then the operational parameter function f₃(ρ) is adjusted accordingly. For example, where the pulp viscosity is known and does not vary over the operation of the separation device, the operational parameter function f₃(ρ) is expressed as an adjusted operational parameter function f*₃(ρ) multiplied by a constant representing the known pulp viscosity value.

Preferably, the frequency of disturbance events is kept proportional to the flux. Alternatively or additionally, the depth of the disturbance zone is kept proportional to the flux.

Where the disturbance zone depth and the flux are constant, the one or more of the disturbance parameters are controlled according to the relationship:

$${S}_{0} = \frac{z \times h \times {f}_{3} ( ρ )}{f}$$

where
S₀ is the optimal disturbance;
z is the frequency, or number of passes, of disturbance events in the disturbance zone within the predetermined period of time;
h is the disturbance zone height or depth function;
f is the flux function; and
f₃(ρ) is the operational parameter function.

Where all the operational parameters remain or are assumed to be constant, the one or more of the disturbance parameters are controlled according to the relationship:

$${S}_{0} = \frac{z \times h \times {k}_{ρ}}{f}$$

where
S₀ is the optimal shear;
z is the frequency, or number of passes, of disturbance events in the disturbance zone within the predetermined period of time;
h is the height or depth of the disturbance zone;
f is the flux; and
k_{ρ} is a constant representing the operational parameters.

Preferably, the disturbing step comprises the step of causing a disturbance substantially uniformly across the disturbance zone so as to disrupt the networked pulp in the disturbance zone within a predetermined period of time, thereby releasing entrained liquid from the networked pulp in the disturbance zone and increasing the relative density of the pulp below the disturbance zone.

Preferably, the disturbance causing step comprises applying shear substantially uniformly across the disturbance zone. More preferably, the shear is applied substantially uniformly across the disturbance zone within the predetermined period of time.

Alternatively, the disturbance causing step comprises creating turbulence substantially uniformly across the disturbance zone.

Preferably, the predetermined period of time substantially corresponds to the time in which the networked pulp passes through the disturbance zone.

Preferably, the disturbance is such that the pulp below the disturbance zone reforms with a substantially higher density relative to the pulp above the disturbance zone. More preferably, the disturbance causing step induces a stepwise increase in the density of the pulp below the disturbance zone. In one preferred form, the density of the pulp below the disturbance zone is at least 5% greater than the density of pulp above the disturbance zone. In another preferred form, the density of the pulp below the disturbance zone is at least 10% greater than the density of pulp above the disturbance zone. In a further preferred form, the density of the pulp below the disturbance zone is at least 25% greater than the density of pulp above the disturbance zone. In yet another preferred form, the density of the pulp below the disturbance zone is at least 35% greater than the density of pulp above the disturbance zone. In a particularly preferred form, the density of the pulp below the disturbance zone is at least 50% greater than the density of pulp above the disturbance zone.

Preferably, the disturbance zone comprises a portion of the hindered zone. More preferably, the disturbance zone comprises a lower portion of the hindered zone. Alternatively, the disturbance zone comprises a portion of the pulp bed (networked pulp layer). In one preferred form, the disturbance zone comprises only an upper portion of the pulp bed (networked pulp layer). In another particularly preferred form, the disturbance zone comprises only the upper half of the pulp bed (networked pulp layer). In a further alternative, the disturbance zone comprises portions of the hindered zone and the pulp bed (networked pulp layer). In one embodiment, the disturbance zone comprises the hindered zone and the pulp bed (networked pulp layer).

More preferably, the disturbance zone is within an upper region of the networked layer of pulp. More preferably, the disturbance zone is within an upper 75% of the networked layer of pulp. Even more preferably, the disturbance zone is within an upper half of the networked layer of pulp. In one preferred form, the disturbance zone is within an upper 30% of the networked layer of pulp. In another preferred form, the disturbance zone is within an upper 10% of the networked layer of pulp. In a particularly preferred form, the disturbance zone is at or adjacent the top of the networked layer of pulp.

In one alternative form, the disturbance zone extends from the upper region of the networked layer of pulp to include a portion of the hindered zone. More preferably, the disturbance zone includes a lower portion of the hindered zone.

Preferably, the disturbance zone comprises a proportion of the upper region of the networked pulp layer. More preferably, the disturbance zone comprises a proportional volume of the upper region.

Preferably, the disturbance zone at least partially comprises a cross-sectional area of the upper region. More preferably, the disturbance zone comprises at least 10% of the cross-sectional area of the upper region within the predetermined period of time. Even more preferably, the disturbance zone comprises at least 30% of the cross-sectional area of the upper region within the predetermined period of time. It is preferred that the disturbance zone comprises at least 50% of the cross-sectional area of the upper region within the predetermined period of time. It is further preferred that the disturbance zone comprises at least 70% of the cross-sectional area of the upper region within the predetermined period of time. In one preferred form, the disturbance zone comprises at least 80% of the cross-sectional area of the upper region within the predetermined period of time. In another preferred form, the disturbance zone comprises at least 90% of the cross-sectional area of the upper region within the predetermined period of time. In a particularly preferred form, the disturbance zone comprises substantially the entire cross-sectional area of the upper region within the predetermined period of time.

Preferably, the shear is applied using a shearing mechanism selected from the group comprising liquid jets, gas jets, mechanical vibrations, ultrasonic impulses, fluidisation and mechanical agitation.

Preferably, the disturbance is caused by mechanical agitation using a shearing device, the method further comprising the step of submerging the shearing device at least partially into the disturbance zone and wherein the controlling step comprises controlling one or more shearing parameters with respect to the flux and/or operational parameters to controllably apply an optimal shear to the networked pulp in the disturbance zone.

Preferably, the method comprises the step of adjusting one or more of the shearing parameters in response to changes in the flux.

Preferably, the method comprises the step of adjusting one or more of the shearing parameters in response to changes in one or more of the operational parameters.

Preferably, the shearing parameters are selected from the group consisting essentially of the speed of the shearing device, the shape of the shearing device and the depth of the shearing region.

Preferably, the method comprises the step of moving the shearing device at a speed with respect to the flux and/or one or more operational parameters. In one preferred form, the shearing device speed is a linear speed of the shearing device. Preferably, the method further comprises the step of rotating the shearing device. In this case, the shearing device speed is the rotational speed of the shearing device.

Preferably, the method comprises the step of controlling the submersion of the shearing device to control the disturbance zone depth with respect to the flux and/or one or more operational parameters. In one preferred form, the shearing device is moved to control its submersion. In another preferred form, the level of the feed material in the tank is adjusted to control the submersion of the shearing device and thus the shear region depth.

Preferably, the method comprises the step of controlling the shearing device shape. More preferably, the shape of the shearing device is adjustable in at least one geometrical axis. In one preferred form, the shearing device is at least partially movable to adjust its shape.

Preferably, one or more of the shearing parameters are controlled according to the relationship:

S₁=f₁(h).f₂(f).f₃(ρ).f₄(λ).f₅(y)

where
S₁ is the optimal shear;
f₁(h) is the disturbance zone height or depth function;
f₂(f) is the flux function;
f₃(ρ) is the operational parameter function;
f₄(λ) is the shear factor function; and
f₅(y) is the shearing device speed function.

The shear factor λ is a variable representing the average shear applied to the aggregates by the shearing device and is therefore a function of the three-dimensional shape and speed of the shearing device. Hence, it is possible to vary the shearing device shape as an additional means to the shearing device speed and shear region depth to control the application of the optimal shear.

In one embodiment the shearing device speed is kept proportional to the flux. Alternatively or additionally, the depth of the disturbance zone is kept proportional to the flux. In a further alternative, the shear factor is kept proportional to the flux, where the shear factor is a function of the shearing device geometry and speed.

Preferably, one or more of shearing parameters are controlled according to the relationship:

$${S}_{1} = \frac{λ \times y \times h \times {f}_{3} ( ρ )}{f}$$

where
S₁ is the optimal shear;
λ is the shear factor;
y is the speed of the shearing device;
h is the height or depth of the disturbance zone;
f is the flux; and
f₃(ρ) is the operational parameter function.

In one embodiment where the operational parameters are kept or assumed to be constant, one or more of the shearing parameters are controlled according to the relationship:

$${S}_{1} = \frac{λ \times y \times h \times {k}_{ρ}}{f}$$

where
S₁ is the optimal shear;
λ is the shear factor;
y is the speed of the shearing device;
h is the height or depth of the disturbance zone;
f is the flux; and
k_{ρ} is a constant representing the operational parameters.

Preferably, the method comprises the step of monitoring the flux of the feed material.

Preferably, the method comprises the step of monitoring one or more of the operational parameters.

Preferably, the operational parameters are selected from the group consisting essentially of the pulp composition, the pulp particle size, the pulp flow velocity in the tank, the pulp yield stress, the pulp viscosity, the underflow specific gravity, the underflow weight per weight percentage and the rate at which flocculant is added to the feed material.

Preferably, the submerging step further comprises submerging the shearing device within the disturbance zone.

Preferably, the method comprises the step of reversibly rotating the shearing device. Preferably, the moving step further comprises periodically reversing the rotation of the shearing device.

Preferably, the method comprises the step of moving the shearing device such that a substantially uniform cumulative shear is applied to the networked pulp in the disturbance zone within the predetermined period of time. Throughout the description and the claims, the term “cumulative shear” means the sum of the shear that is applied to a typical pulp aggregate or particle passing through a defined region. In this context, the cumulative shear is the total sum of shear that a typical pulp aggregate or particle experiences between its entry into and exit from the region, which is determined by the sum of “shear” events that have occurred and the magnitude of those shear events; that is, the number of times the typical pulp aggregate or particle has been “hit” (a shear force has been applied to it). These shear events not only include direct “hits” of the pulp aggregate or particle by the shearing device but also disturbances or “shaking” of the pulp aggregate or particle caught in the wake of the passage of the shearing device, which the inventors call a “zone of turbulence”. These zones of turbulence are sufficient to apply a shear force to the pulp aggregate or particle, albeit less than the amount of shear directly applied by the shearing device.

Preferably, the shearing device moves within the disturbance zone. More preferably, the shearing device rotates within the disturbance zone.

Preferably, the moving step comprises applying shear to at least a radial cross-section of the disturbance zone. More preferably, the shearing device moves at least partially through the radial cross-section of the disturbance zone. Preferably, the moving step comprises applying shear to at least a diametrical cross-section of the disturbance zone. More preferably, the shearing device moves at least partially through the diametrical cross-section of the disturbance zone.

Preferably, the method comprises rotating the shearing device about a central axis of the tank. Preferably, the central axis is substantially vertical with respect to the tank.

Alternatively, the moving step further comprises rotating the shearing device about an axis of rotation that is parallel, eccentric or offset with respect to a central axis of the tank. Preferably, the method comprises the step of moving the axis of rotation relative to the central axis. More preferably, the axis of rotation rotates, revolves or orbits at least partially around the central axis. In one preferred form, the axis of rotation at least partially traverses a regular path around the central axis. Alternatively, the axis of rotation at least partially traverses an irregular path around the central axis. In some embodiments, the axis of rotation moves in a circular path. In other embodiments, however, the axis of rotation moves in a non-circular path, which may be geometrically regular or irregular.

Preferably, the method comprises rotatably mounting the shearing device to a support and disposing the support for movement about the central axis. More preferably, the method comprises rotating the support about the central axis. In one embodiment, a central drive shaft extending axially through the tank moveably drives the support. In another embodiment, the support is moveably driven by a drive mechanism arranged at an outer edge of the tank, preferably a peripheral drive. In a further embodiment, the support is moveably driven by a drive shaft concentric to the central drive shaft.

Preferably, the method comprises disposing the support adjacent the top of the tank. Alternatively, the method comprises disposing the support adjacent the bottom of the tank. In one embodiment, the support comprises a service bridge extending radially from the central drive shaft above the tank.

In a further alternative, the moving step further comprises moving the shearing device substantially parallel to a central axis of the tank. Preferably, the method comprises the step of moving the shearing device substantially vertically with respect to the pulp bed. In one preferred form, the shearing device substantially reciprocates vertically.

Preferably, the method further comprises the step of providing the shearing device with a plurality of shearing elements. Preferably, the method comprises the steps of defining a zone of turbulence for each shearing element to disturb, re-arrange or break-up the pulp aggregates and/or to release liquid.

Preferably, the method further comprises the step of spacing apart the shearing elements along at least one arm of the shearing device to define intervals therebetween so that a substantially uniform average shear is applied to the pulp in at least two intervals along a line parallel to or coincident with the at least one arm. More preferably, the average shear in all the intervals between the shearing elements along the line is substantially uniform or the same. Throughout the description and the claims, the term “average shear” means the average of shear applied to pulp between any two predetermined reference points. In this context, the two reference points typically (but not necessarily) coincide with adjacent shearing elements disposed on the at least one arm of the shearing device.

It will be appreciated that in the method, the line may be non-linear in whole or part. For example, the line may include a portion that is arcuate, angled or offset with respect to a straight portion of the line. In one preferred form, the line is a radial line.

Preferably, the method comprises the steps of providing the shearing device with at least two shearing arms supported for movement within the disturbance zone and a plurality of shearing elements, and applying shear to the networked pulp. In one preferred form, the method comprises the steps of providing the shearing device with at least three shearing arms supported for rotation within the disturbance zone. Preferably, the method further comprises the step of providing a plurality of shearing elements for applying shear to the networked pulp. Preferably, the method comprises the steps of defining a zone of turbulence for disrupting the networked pulp.

Preferably, the method further comprises the step of spacing apart two or more shearing elements along at least one arm of the shearing device to define respective intervals therebetween so that a substantially uniform average shear is applied to the pulp in at least two intervals along a line parallel to or coincident with the at least one arm. More preferably, the average shear in all the intervals between the shearing elements along the line is substantially uniform or the same. It will be appreciated that in the method, the line may be non-linear in whole or part. For example, the line may include a portion that is arcuate, angled or offset with respect to a straight portion of the line. In one preferred form, the line is a radial line.

In one preferred form, the method further comprises the step of providing the shearing device with at least two outwardly extending arms. Preferably, the method comprises extending the arms radially outward substantially to an outer perimeter of the region. Preferably, the method comprises applying substantially uniform average shear along the length of the arms. Preferably, the method comprises the step of moving the arms in a direction substantially parallel to the axis of rotation. Preferably, the method comprises the step of substantially reciprocating the arms.

Preferably, the method comprises the step of disposing one or more shearing elements along the axis of rotation to extend radially outwardly. Preferably, the method comprises the step of removably mounting the one or more shearing elements to a drive shaft of the shearing device.

Alternatively, the method comprises the step of disposing one or more shearing elements on the arms. Preferably, the method comprises arranging the shearing elements to apply shear along the arms.

Preferably, the method further comprises the step of extending the shearing elements at an angle of inclination with respect to a vertical plane. In one preferred form, the vertical plane is parallel to the arm. In another preferred form, the vertical plane is at right angles to the arm. Preferably, the angle of inclination is between 30° and 50°, and most preferably around 45°. Preferably, the method further comprises the step of adjusting the angle of inclination of the shearing elements. Preferably, the method further comprises the step of supporting the shearing elements from the central axis of the tank.

Preferably, the method comprises providing the shearing device with at least one partially planar plate having a plurality of openings. In one preferred form, the method comprises slidably moving the at least one partially planar plate. More preferably, the method comprises forming the at least one partially planar plate to have a shape complementary to a horizontal cross-section of the tank. In a particularly preferred form, the plate is a horizontal disc. Preferably, the method comprises evenly spacing the openings with respect to one another. Preferably, the openings are substantially uniform in size.

In another preferred form, the method comprises rotating the at least one partially planar plate about an axis of rotation. Preferably the at least one partially planar plate is arranged to be substantially vertical. Preferably, the method comprises progressively increasing the size of one or more openings from the axis of rotation to an outer edge of the at least one partially planar plate. Preferably, the method comprises substantially aligning one or more openings.

Preferably, the method comprises the step of providing a central drive shaft to drive rotation of the shearing device. Alternatively, the method comprises the step of driving movement of the shearing device independently of a central drive shaft. In one preferred form, the method comprises the step of arranging the independent drive mechanism at an outer edge of the tank, preferably a peripheral drive.

In another preferred form, the method comprises the step of arranging the independent drive mechanism to operate a drive shaft concentric to the central drive shaft for moving the shearing device. Preferably, the method comprises the concentric drive shaft moving the shearing device substantially parallel to the central drive shaft. More preferably, the concentric drive shaft substantially reciprocates the shearing device.

According to a second aspect, the invention provides a separation device for separating pulp from a feed material, the separation device comprising a tank for receiving the feed material at a flux and a disturbance causing device for disturbing networked pulp in a disturbance zone of a networked layer that is formed from pulp settling out of the feed material, wherein one or more disturbance parameters are controlled with respect to the flux and/or one or more operational parameters to controllably apply an optimal disturbance to networked pulp in the disturbance zone.

Preferably, one or more of the disturbance parameters are adjustable in response to changes in the flux.

Preferably, one or more of the disturbance parameters are adjustable in response to changes in one or more of the operational parameters.

Preferably, the disturbance parameters are selected from the group consisting essentially of the frequency of the disturbance events in the disturbance zone and the depth of the disturbance zone.

Preferably, one or more of the disturbance parameters are controlled according to the relationship:

S₀=z.f₁(h).f₂(f).f₃(ρ)

where
S₀ is the optimal disturbance;
z is the frequency, or number of passes, of disturbance events in the disturbance zone within the predetermined period of time;
f₁(h) is the disturbance zone height or depth function;
f₂(f) is the flux function; and
f₃(ρ) is the operational parameter function.

Preferably, the frequency of disturbance events is kept proportional to the flux. Alternatively or additionally, the depth of the disturbance zone is kept proportional to the flux.

Preferably, the disturbance causing device causes a disturbance substantially uniformly across the disturbance zone so as to disrupt the networked pulp in the disturbance zone within a predetermined period of time, thereby releasing entrained liquid from the networked pulp in the disturbance zone and increasing the relative density of the pulp below the disturbance zone

Preferably, the disturbance causing device applies shear substantially uniformly across the disturbance zone. More preferably the disturbance causing device applies shear substantially uniformly across the disturbance zone within the predetermined period of time.

Alternatively, the disturbance causing device applies shear creates turbulence substantially uniformly across the disturbance zone.

Preferably, the predetermined period of time substantially corresponds to the time in which the networked pulp passes through the disturbance zone.

Preferably, the shear is applied using a shearing mechanism selected from the group comprising liquid jets, gas jets, mechanical vibrations, ultrasonic impulses, fluidisation and mechanical agitation.

Preferably, the disturbance is such that the pulp below the disturbance zone reforms with a substantially higher density relative to the pulp above the disturbance zone. More preferably, the disturbance causing step induces a stepwise increase in the density of the pulp below the disturbance zone. In one preferred form, the density of the pulp below the disturbance zone is at least 5% greater than the density of pulp above the disturbance zone. In another preferred form, the density of the pulp below the disturbance zone is at least 10% greater than the density of pulp above the disturbance zone. In a further preferred form, the density of the pulp below the disturbance zone is at least 25% greater than the density of pulp above the disturbance zone. In yet another preferred form, the density of the pulp below the disturbance zone is at least 35% greater than the density of pulp above the disturbance zone. In a particularly preferred form, the density of the pulp below the disturbance zone is at least 50% greater than the density of pulp above the disturbance zone.

Preferably, the disturbance zone comprises a portion of the hindered zone. More preferably, the disturbance zone comprises a lower portion of the hindered zone. Alternatively, the disturbance zone comprises a portion of the pulp bed (networked pulp layer). In one preferred form, the disturbance zone comprises only an upper portion of the pulp bed (networked pulp layer). In another particularly preferred form, the disturbance zone comprises only the upper half of the pulp bed (networked pulp layer). In a further alternative, the disturbance zone comprises portions of the hindered zone and the pulp bed (networked pulp layer). In one embodiment, the disturbance zone comprises the hindered zone and the pulp bed (networked pulp layer).

More preferably, the disturbance zone is within an upper region of the networked layer of pulp. More preferably, the disturbance zone is within an upper 75% of the networked layer of pulp. Even more preferably, the disturbance zone is within an upper half of the networked layer of pulp. In one preferred form, the disturbance zone is within an upper 30% of the networked layer of pulp. In another preferred form, the disturbance zone is within an upper 10% of the networked layer of pulp. In a particularly preferred form, the disturbance zone is at or adjacent the top of the networked layer of pulp.

In one alternative form, the disturbance zone extends from the upper region of the networked layer of pulp to include a portion of the hindered zone. More preferably, the disturbance zone includes a lower portion of the hindered zone.

Preferably, the disturbance zone comprises a proportion of the upper region of the networked pulp layer. More preferably, the disturbance zone comprises a proportional volume of the upper region.

Preferably, the disturbance zone at least partially comprises a cross-sectional area of the upper region. More preferably, the disturbance zone comprises at least 10% of the cross-sectional area of the upper region within the predetermined period of time. Even more preferably, the disturbance zone comprises at least 30% of the cross-sectional area of the upper region within the predetermined period of time. It is preferred that the disturbance zone comprises at least 50% of the cross-sectional area of the upper region within the predetermined period of time. It is further preferred that the disturbance zone comprises at least 70% of the cross-sectional area of the upper region within the predetermined period of time. In one preferred form, the disturbance zone comprises at least 80% of the cross-sectional area of the upper region within the predetermined period of time. In another preferred form, the disturbance zone comprises at least 90% of the cross-sectional area of the upper region within the predetermined period of time. In a particularly preferred form, the disturbance zone comprises substantially the entire cross-sectional area of the upper region within the predetermined period of time.

Preferably, the disturbance causing device comprises a shearing device submersible at least partially into a region of the tank to apply shear to the networked pulp in the disturbance zone and wherein one or more shearing parameters are controlled with respect to the flux and/or operational parameters to controllably apply an optimal shear to the networked pulp in the disturbance zone.

Preferably, one or more of the shearing parameters are adjustable in response to changes in the flux.

Preferably, one or more of the shearing parameters are adjustable in response to changes in one or more of the operational parameters.

Preferably, the shearing device is moved at a speed with respect to the flux and/or one or more of the operational parameters. In one preferred form, the shearing device speed is a linear speed of the shearing device. Preferably, the shearing device is rotatable at least partially within the region. In this case, the shearing device speed is the rotational speed of the shearing device.

Preferably, the shearing device is controllably submerged into the disturbance zone to control the disturbance zone depth with respect to the flux and/or one or more of the operational parameters. In one preferred form, the shearing device is moved to control its submersion. In another preferred form, the level of the suspension is adjusted to control the submersion of the shearing device and thus the disturbance zone depth.

Preferably, the shearing device controls its shape with respect to the flux and/or one or more of the operational parameters. More preferably, the shearing device is adjustable in shape in at least one geometrical axis. In one preferred form, the shearing device is at least partially movable to adjust its shape.

Preferably, the one or more of the shearing parameters are controlled according to the relationship:

S₁=f₁(h).f₂(f).f₃(ρ).f₄(λ).f₅(y)

where
S₁ is the optimal shear;
f₁(h) is the disturbance zone height or depth function;
f₂(f) is the flux function;
f₃(ρ) is the operational parameter function;
f₄(λ) is the shear factor function; and
f₅(y) is the shearing device speed function

Preferably, the shearing device speed is kept proportional to the flux. Preferably, the depth of the disturbance zone is kept proportional to the flux. Preferably, the shear factor is kept proportional to the flux, where the shear factor is a function of the shearing device geometry and speed. Preferably, one or more of the shearing parameters are controlled according to the relationship:

$${S}_{1} = \frac{λ \times y \times h \times {f}_{3} ( ρ )}{f}$$

where
S₁ is the optimal shear;
λ is the shear factor;
y is the speed of the shearing device;
h is the depth of the disturbance zone;
f is the flux and
f₃(ρ) is the operational parameter function.

In one embodiment where the operational parameters are kept or assumed to be constant, one or more of the shearing parameters are controlled according to the relationship:

$${S}_{1} = \frac{λ \times y \times h \times {k}_{ρ}}{f}$$

where
S₁ is the optimal shear;
λ is the shear factor;
y is the speed of the shearing device;
h is the height or depth of the disturbance zone;
f is the flux; and
k_{ρ} is a constant representing the operational parameters.

Preferably, the separation device comprises a sensor for monitoring the flux of the suspension and a control unit in communication with the sensor to controllably adjust one or more of the shearing parameters.

Preferably, the separation device comprises one or more sensors for respectively monitoring one or more of the operational parameters, wherein the operational parameter sensors are in communication with the control unit to controllably adjust one or more of the shearing parameters.

Preferably, the shearing device is submerged within the disturbance zone.

Preferably, the disturbance zone is within an upper region of the networked layer of pulp. More preferably, the disturbance zone is within an upper 75% of the networked layer of pulp. Even more preferably, the disturbance zone is within an upper half of the networked layer of pulp. In one preferred form, the disturbance zone is within an upper 30% of the networked layer of pulp. In another preferred form, the disturbance zone is within an upper 10% of the networked layer of pulp. In a particularly preferred form, the disturbance zone is at or adjacent the top of the networked layer of pulp.

In one alternative form, the disturbance zone extends from the upper region of the networked layer of pulp to include a portion of the hindered zone. More preferably, the disturbance zone includes a lower portion of the hindered zone.

Preferably, the shearing device applies shear substantially uniformly across the disturbance zone so as to disrupt the networked pulp in the disturbance zone within a predetermined period of time, thereby releasing entrained liquid from the networked pulp in the disturbance zone and increasing the relative density of the pulp below the disturbance zone.

Preferably, the shearing device comprises at least two shearing arms supported for movement within the disturbance zone. In one preferred form, the shearing device comprises at least three shearing arms supported for rotation within the disturbance zone. More preferably, the shearing device comprises a plurality of shearing elements for applying shear to the networked pulp. Preferably, the shearing elements each define a zone of turbulence for disrupting the networked pulp.

Preferably, the shearing device applies shear to at least a radial cross-section of the disturbance zone. More preferably, the shearing device moves at least partially through the radial cross-section of the disturbance zone. Preferably, the shearing device applies shear to at least a diametrical cross-section of the disturbance zone. More preferably, the shearing device moves at least partially through the diametrical cross-section of the disturbance zone.

Preferably, the shearing device is moved such that a substantially uniform cumulative shear is applied to the networked pulp in the disturbance zone within the predetermined period of time.

Preferably, the shearing device is reversibly rotatable. Preferably, the rotation of the shearing device is periodically reversible.

Preferably, the shearing device rotates about a central axis of the tank. More preferably, the central axis is substantially vertical with respect to the tank.

Alternatively, the axis of rotation of the shearing device is parallel, eccentric or offset with respect to a central axis of the tank. Preferably, the axis of rotation is movable relative to the central axis. Preferably, the axis of rotation rotates, revolves or orbits at least partially around the central axis. In one preferred form, the axis of rotation at least partially traverses a regular path around the central axis. In another preferred form, the axis of rotation at least partially traverses an irregular path around the central axis. In some embodiments, the axis of rotation moves in a circular path. In other embodiments, however, the axis of rotation moves in a non-circular path, which may be geometrically regular or irregular.

Preferably, the shearing device is rotatably mounted to a support, the support being disposed for movement about the central axis. More preferably, the support is rotatable about the central axis. In one embodiment, the support is movably driven by a central drive shaft extending axially through the tank. In another embodiment, the support is movably driven by a drive mechanism arranged at an outer edge of the tank, preferably a peripheral drive. In a further embodiment, the support is movably driven by a drive shaft concentric to the central drive shaft.

Preferably, the support is disposed adjacent the top of the tank. Alternatively, the support is disposed adjacent the bottom of the tank. In one embodiment, the support includes a service bridge extending radially from the central drive shaft above the tank.

In yet another alternative, the shearing device moves substantially parallel to a central axis of the tank to induce the substantially uniform cumulative shear. Preferably, the shearing device moves substantially vertically with respect to the pulp bed. In one preferred form, the shearing device substantially reciprocates vertically.

Preferably, the shearing device comprises a plurality of shearing elements. Preferably, the shearing elements are spaced apart along at least one arm of the shearing device to define respective intervals therebetween, such that a substantially uniform average shear is applied in at least two intervals, along a line parallel to or coincident with the at least one arm. More preferably, the average shear in all the intervals between the shearing elements along the line is substantially uniform or the same.

It will be appreciated that the line may be non-linear in whole or part. For example, the line may include a portion that is arcuate, angled or offset with respect to a straight portion of the line. In one preferred form, the line is a radial line.

Preferably, the shearing elements each define a zone of turbulence to disturb, re-arrange or break-up pulp aggregates and/or to release liquid, the shearing elements being disposed to increase their respective turbulence zones.

Preferably, the shearing device applies a substantially uniform number of shear events to the networked pulp in the disturbance zone within the predetermined period of time.

Preferably, the shearing device applies a combination of at least two of substantially uniform average shear, substantially uniform cumulative shear and a substantially uniform number of shear events. More preferably, the shearing device applies a substantially uniform average shear, substantially uniform cumulative shear and a substantially uniform number of shear events to the networked pulp.

In one preferred form, the shearing device comprises at least two outwardly extending arms. Preferably, one or more shearing elements are disposed on the arms. Preferably, the shearing elements apply shear along the arms. Preferably, the shearing device applies substantially uniform average shear along the length of the arms. Preferably, the arms extend radially outwardly substantially to an outer perimeter of the region.

Preferably, the arms are movable in a direction substantially parallel to the axis of rotation. More preferably, the arms substantially reciprocate.

In another preferred form, one or more shearing elements are disposed along the axis of rotation to extend radially outwardly. Preferably, the shearing device has a drive shaft and the one or more shearing elements are removably mountable on the drive shaft. More preferably, the shearing device comprises a collar for removably mounting the one or more shearing elements on the drive shaft.

Preferably, two or more shearing elements are arranged asymmetrically about the axis of rotation of the shearing device.

Preferably, one or more shearing elements are spaced at uneven intervals with respect to each other. Preferably, the uneven intervals progressively increase from the axis of rotation to an outer edge of at least one arm. As a result, the number of the shearing elements progressively decreases from the axis of rotation of the shearing device to an outer edge of at least one arm. In one preferred form, the uneven intervals are respectively proportional to the radial distances from the axis of rotation to the shearing elements.

Preferably, the shearing elements define a tapered profile of the shearing device. More preferably, the shearing elements progressively decrease in length from the axis of rotation of the shearing device to an outer edge of at least one arm.

Preferably, one or more shearing elements progressively decrease in thickness from the axis of rotation of the shearing device to an outer edge of at least one arm.

Preferably, one or more shearing elements extend at an angle of inclination with respect to a vertical plane. In one preferred form, the vertical plane is parallel to the arm. In another preferred form, the vertical plane is at right angles to the arm. Preferably, the angle of inclination is between 30° and 50°, and most preferably around 45°. Preferably, the angle of inclination is adjustable. Preferably, one or more shearing elements are hingedly or pivotally mounted to the arms to adjust the angle of inclination. Preferably, one or more shearing elements are supported by one or more angled arms extending from a central drive shaft of the separation device.

Preferably, one or more shearing elements are substantially linear in shape. Alternatively, one or more shearing elements have a non-linear configuration. For example, the shearing element(s) may be helical, spiral or curved, in whole or part. In preferred embodiments, the shearing elements are formed from rods, pickets, blades, bars, wires, chains, sheets, plates, screen elements or mesh elements.

Preferably, the shearing device comprises at least one partially planar plate having a plurality of openings. In one preferred form, the at least one partially planar plate is adapted for substantially slidable movement. More preferably, the at least one partially planar plate has a shape complementary to a horizontal cross-section of the tank. In a particularly preferred form, the plate is a horizontal disc. Preferably, the openings are evenly spaced with respect to one another. Preferably, the openings are substantially uniform in size.

In another preferred form, the at least one partially planar plate is adapted for rotation about an axis of rotation. Preferably the at least one partially planar plate is arranged to be substantially vertical. Preferably, one or more openings progressively increase in size from the axis of rotation to an outer edge of the at least one partially planar plate. Preferably, one or more openings are substantially aligned.

Preferably, the shearing device comprises a plurality of shearing elements arranged in a pattern. In one preferred form, two or more shearing elements are interconnected to form a mesh-like pattern. The mesh-like pattern may be partially or fully geometrical, and preferably comprises rectangular, square, diamond, triangular, hexagonal or other polygonal shapes. In another preferred form, two or more shearing elements form one or more geometrical shapes. Preferably, the geometrical shapes are complementary in shape. Preferably, the geometrical shapes form a web-like pattern. Preferably, the geometrical shapes comprise rectangular, square, diamond, triangular, hexagonal or other polygonal shapes.

Preferably, the shearing device is disposed above the rake assembly. In one preferred form, the rake assembly is located adjacent the bottom of the tank.

Preferably, the average cumulative shear is at least substantially within 20% above or below a predetermined optimal shear value. Preferably, the average cumulative shear is at least substantially within 30% above or below the predetermined optimal shear value. Preferably, the average cumulative shear is at least substantially within 40% above or below the predetermined optimal shear value. Preferably, the average cumulative shear is at least substantially within 50% above or below the predetermined optimal shear value. Throughout the description and claims, the term “average cumulative shear” means the average of the entire cumulative shear that is applied to the proportion of the pulp exiting the region. For example, where cumulative shear is applied to a cylindrical region, the average cumulative shear is the average of the cumulative shear taken over an area of a horizontal disc parallel to and adjacent the exit of the cylindrical region.

Preferably, the separation device comprises a central drive shaft to drive rotation of the shearing device. Alternatively, the separation device comprises a drive mechanism independent of a central drive shaft to drive movement of the shearing device. In one preferred form, the independent drive mechanism comprises a drive mechanism arranged at an outer edge of the tank. Preferably, the independent drive mechanism is a peripheral drive.

In another preferred form, the independent drive mechanism comprises a drive shaft concentric to a central drive shaft of the tank. Preferably, the concentric drive shaft rotates the shearing device. Alternatively, the concentric drive shaft moves the shearing device substantially parallel to the central drive shaft. More preferably, the concentric drive shaft substantially reciprocates the shearing device.

Preferably, the separation device is a thickener.

### BRIEF DESCRIPTION OF THE DRAWINGS

Preferred embodiments of the invention will now be described, by way of example only, with reference to the accompanying drawings in which:

FIG. 1A is a schematic cross-sectional view of the typical zones of material within a separation device;

FIG. 1B is a schematic cross-sectional view illustrating the settling process in the separation device of FIG. 1;

FIG. 1C is a schematic diagram illustrating the method of the invention;

FIG. 2A is a schematic diagram view of a method according to a first embodiment of the invention;

FIG. 2B is a schematic diagram view of a method according to a second embodiment of the invention;

FIG. 3 is a schematic diagram of a method according to a third embodiment of the invention;

FIG. 4 is a cross-sectional view of a separation device according to one embodiment of the invention;

FIG. 5A shows a graph of the underflow density against the flux, comparing the separation device of FIG. 4 with a conventional thickener;

FIG. 5B shows a graph of the underflow density against the shearing device speed, for the separation device of FIG. 4;

FIG. 6A shows a graph of the underflow density against the shearing device speed for the separation device of FIG. 4;

FIG. 6B shows a graph of the underflow density against the shearing device speed for the separation device of FIG. 4;

FIG. 7A shows a graph of the underflow density against the disturbance zone, or shear region, depth for the shearing device of FIG. 4;

FIG. 7B shows a graph of the underflow density against the three-dimensional geometrical shape for a modified shearing device of FIG. 4;

FIGS. 7C and 7D are schematic cross-sectional views of the modified shearing device of FIG. 7B illustrating the change in its three-dimensional geometrical shape;

FIG. 8 is a cross-sectional view of separation device according to another embodiment of the invention;

FIG. 9A is a cross-sectional view of separation device according to a further embodiment of the invention;

FIG. 9B is a cross-sectional view of separation device according to yet another embodiment of the invention;

FIG. 9C is a cross-sectional view of separation device according to a further embodiment of the invention;

FIG. 10A is a cross-sectional view of another shearing device for use in the separation device of FIG. 8;

FIG. 10B is a cross-sectional view of a further shearing device for use in the separation device of FIG. 8;

FIG. 11 is a cross-sectional view of yet another shearing device for use in the separation device of FIG. 8;

FIG. 12 is a cross-sectional view of a separation device according to a further embodiment of the invention;

FIG. 13 is a cross-sectional view of a separation device according to yet another embodiment of the invention;

FIG. 14 is a plan view of a separation device according to a yet further embodiment of the invention;

FIG. 15 is a cross-sectional view of a separation device according to a further embodiment of the invention;

FIG. 16 is a cross-sectional view of separation device according to yet further embodiment of the invention;

FIG. 17 is a cross-sectional view of a separation device in accordance with a further embodiment of the invention;

FIG. 18A is a plan view of a shearing device for use in the separation device of FIG. 16;

FIG. 18B is a front view of the shearing device illustrated in FIG. 18A;

FIG. 19A is a plan view of a shearing device for use in the separation device of FIG. 16;

FIG. 19B is a front view of the shearing device illustrated in FIG. 19A;

FIG. 20A is a plan view of a shearing device for use in the separation device of FIG. 16;

FIG. 20B is a front view of the shearing device illustrated in FIG. 20A;

FIG. 21A is a plan view of a shearing device for use in the separation device of FIG. 16;

FIG. 21B is a front view of the shearing device illustrated in FIG. 21A;

FIG. 22A is a plan view of a shearing device for use in the separation device of FIG. 16; and

FIG. 22B is a front view of the shearing device illustrated in FIG. 22A.

### PREFERRED EMBODIMENTS OF THE INVENTION

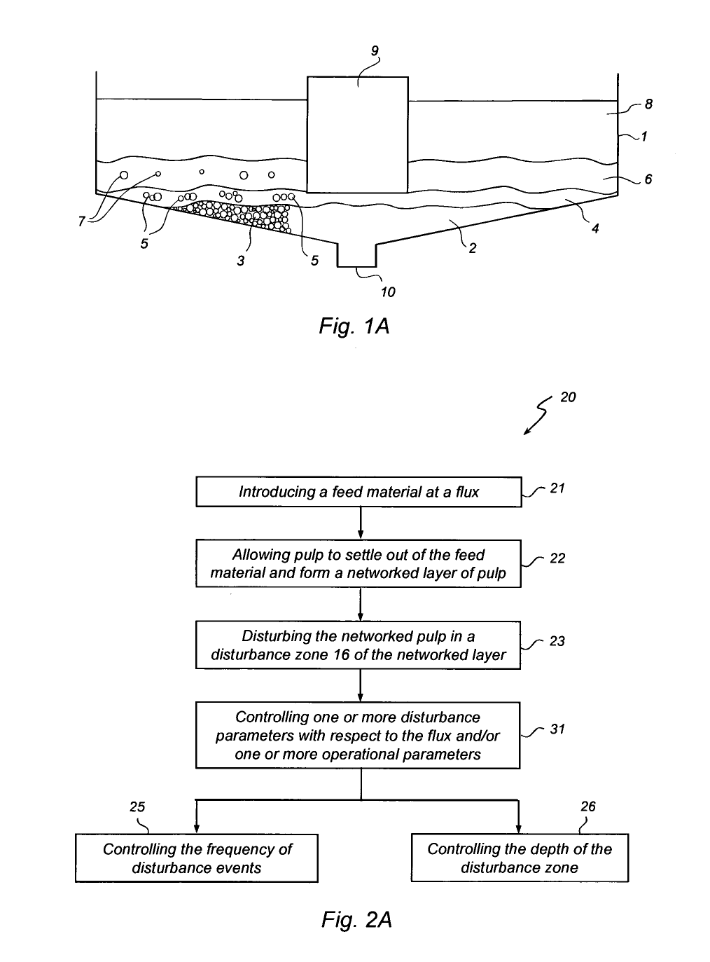

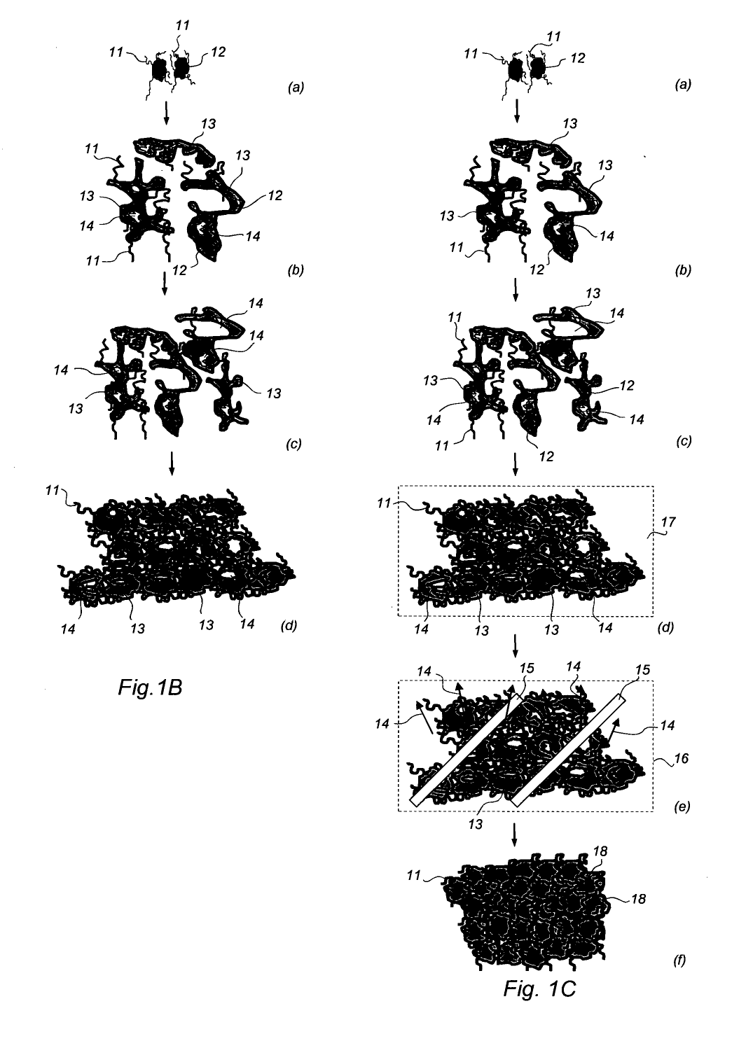

A preferred application of the invention is in the fields of mineral processing, separation and extraction, whereby finely ground ore is suspended as pulp in a suitable liquid medium such as water at a consistency which permits flow, and settlement in quiescent conditions. The pulp is settled from the suspension by a combination of gravity with or without chemical and/or mechanical processes. The pulp gradually clumps together to form aggregates of larger pulp particles as it descends from the feedwell towards the bottom of the tank. This process is typically enhanced by the addition of flocculating agents, also known as flocculants, which bind the settling solid or pulp particles together. These larger and denser pulp aggregates settle more rapidly than the individual particles by virtue of their overall size and density relative to the surrounding liquid, gradually forming a compacted arrangement within the pulp bed, as best shown in FIG. 1. Nevertheless, despite this compacted arrangement, it has been found that areas occur within the pulp bed where liquid remains trapped within and between the aggregates. As it is difficult for this trapped liquid to escape the pulp bed into the clarified zone of dilute liquor, the underflow density of the pulp is diminished.

The settling of pulp as it passes through the zones in a thickening tank 1 is described in more detail with reference to FIG. 1B, where corresponding features have been given the same reference numerals. Within the feedwell 9, flocculant 11 is added and adsorbs onto discrete pulp particles 12, as best shown in FIG. 1B(a). The flocculant 11 and pulp particles 12 grow and loosely bind together into porous pulp aggregates 13 within the feedwell 9 and/or as the pulp particles 12 flow out of the feedwell 9 into the free settling zone 6, as best shown in FIG. 1B(b). Due to their porous nature, liquid 14 is trapped within individual pulp aggregates. As the pulp aggregates 13 further descend in the tank 1 through the free settling zone 6 and into the hindered zone 4, they become crowded and impede settling of each other, as best shown in FIG. 1B(c). Gradually, the pulp aggregates 14 consolidate and compact together into an organised networked layer 2 of pulp, also called a pulp bed, as best shown in FIG. 1B(d). Nevertheless, despite this compacted arrangement of the networked pulp layer 2, it has been found that areas occur within the networked pulp layer where liquid remains trapped within and between the aggregates in the networked layer of pulp. As it is difficult for this trapped liquid to escape the pulp bed into the clarified zone of dilute liquor, the underflow density of the pulp is diminished.

The inventors have unexpectedly and surprisingly found that by causing a disturbance to the networked layer of pulp, trapped liquid is released and the relative density of the disturbed pulp is increased, thus improving the settling efficiency of the separation device. The inventors have also surprisingly discovered that this improved settling effect is best achieved by carefully controlling the disturbance to the pulp bed at an optimum level, as distinct from a minimum level. If the networked layer is disturbed too much, fractionation of the networked pulp into smaller pieces occurs, resulting in the smaller pieces settling more slowly. Too little disturbance fails to disrupt the networked pulp sufficiently to release enough liquid to improve settling efficiency.

Thus, the inventors have unexpectedly and surprisingly found that the optimal disturbance for achieving this improved separation efficiency continuously over the work cycles of the separation device is obtained by controlling or adjusting one or more disturbance parameters with respect to the flux (throughput) of the incoming feed material, which is typically a suspension, into the separation device, one or more operational parameters or a combination of both. These disturbance parameters comprise the frequency of disturbance events in the disturbance zone within the predetermined period of time and the depth of the disturbance zone. This unexpected and surprising discovery means that the disturbance to the networked pulp in the disturbance zone can be optimally controlled in accordance with operational requirements, especially variations in the supply of the suspension, whilst maintaining the improved separation efficiency in the separation device. In the case of a thickener, the application of the method results in improvements in the recovered underflow density of the settled pulp relative to the amount of flux or throughput of the liquid slurry that is processed by the thickener.

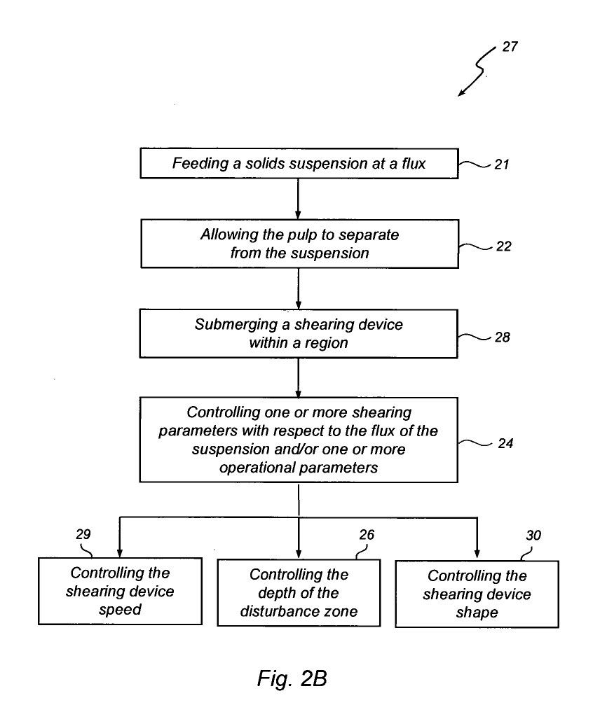

Also, the inventors have unexpectedly and surprisingly found that the optimal disturbance for achieving this improved separation efficiency continuously over the work cycles of the separation device is obtained by causing the disturbance substantially uniformly across a disturbance zone in a region of the networked layer, preferably an upper region, as best shown in FIG. 1C where corresponding features have been given the same reference numerals. As shown in FIGS. 1C(a) to 1C(d), flocculant is added into the feedwell 9 to adsorb onto discrete pulp particles 12 to promote the formation of aggregates 13 that descend and form a networked layer of pulp. Unlike the conventional settling process illustrated in FIG. 2A, where the pulp aggregates 13 are left alone during formation of the networked layer 2, a disturbance 15 is caused substantially uniformly across within a disturbance zone 16 in an upper region 17 of the networked layer 2, as best shown in FIG. 1C(e). As a consequence, a proportion of the networked pulp 3 (being the networked pulp that passes through the disturbance zone 16) is disrupted to release liquid 14 trapped within the networked pulp, thus increasing the relative density of the pulp 18 below the disturbance zone 16, as best shown in FIG. 1C(f).

In particular, it has been discovered that an advantageous implementation of the disturbance causing step is to apply shear substantially uniformly across the disturbance zone. The mechanism by which shear is applied in the disturbance causing step can take a number of forms. For example, one shearing mechanism is to use liquid or gas jets to inject a liquid or gas towards, into or through the disturbance zone 16 to apply shear substantially uniformly across the disturbance zone. Similarly, a fluidiser can direct fluid flow towards, into or through the disturbance zone 16 to apply shear substantially uniformly across the disturbance zone. Other shearing mechanisms include subjecting the disturbance zone 16 to mechanical vibration using a suitable vibratory apparatus or ultrasonic impulses to apply shear substantially uniformly across the disturbance zone. While these shearing mechanisms are suitable for implementing the disturbance causing (shearing) step in the method of the invention, the inventors have determined that a preferred shearing mechanism is mechanical agitation, advantageously by way of a shearing device that moves through the disturbance zone 16 to apply shear substantially uniformly across the disturbance zone. In one preferred form, the shearing device is rotated in the tank in accordance with the disturbance causing (shearing) step.

The inventors have unexpectedly and surprisingly discovered that it is particularly advantageous for the disturbance causing device or shearing device to be located in the upper region, especially the upper half, of the pulp bed 2, as the liquid is readily able to escape the pulp bed 2 into the clarified zone 8 of dilute liquor. By way of contrast, causing a disturbance or applying a shear force in only the bottom half of the pulp bed 2 will release liquid upwardly, however, the undisturbed upper layer of the pulp bed tends to produce a blanketing effect that hinders or even prevents further upward migration of the liquid into the clarified zone 8. Thus, the improved efficiency attained by the disturbance causing device or shearing device is not as effectively achievable in the bottom half of the pulp bed 2, as it is in the upper portion, particularly in the upper half. In addition, the disturbance or shear applied to the region 43 is not constrained by the need to minimise the speed of the disturbance causing device or the rotation speed of the shearing device, as it has been unexpectedly and surprisingly found that a greater amount of disturbance or shear produced by the increased speed does not adversely affect the compaction of the pulp solids in the pulp bed 2. It has also been found that shearing in the top half of the pulp bed 2 in a counter-rotation with respect to the rotation of the rake assembly 21 at the bottom of the pulp bed further enhances donut minimisation and prevention.

The inventors also contemplate that this advantageous effect can be extended to a portion of the hindered zone 4 above the pulp bed 2, especially a lower portion of the hindered zone. That is, the disturbance causing device or shearing device may be located only in the hindered zone 4, or both the networked pulp layer 2 and the hindered zone. For example, any one of the shearing devices described in more detail below may be located so as to cause a disturbance or apply shear in an upper region of the networked pulp layer 2 and a lower portion of hindered zone 4. However, as stated above, the inventors have determined that the disturbance causing device or shearing device is ideally located in an upper region of the networked pulp layer 2, to obtain the most benefit of the invention's advantageous effects.

The application of shear, substantially uniformly across the disturbance zone 16 results in an increased probability of the networked pulp receiving a disturbance that disrupts its generally organised structure. The disturbance may also disrupt the continuous contact between the networked pulp. The disruption can take the form of shaking or disturbing the networked pulp. Alternatively, or cumulatively, the disruption can take the form of re-arranging, re-orienting or breaking up the networked pulp. In both cases, the disruption has the effect of releasing liquid 14 trapped in the networked pulp, either between pulp aggregates or within a pulp aggregate. Thus, a substantial proportion of this trapped liquid 14 is released upwardly out of the networked pulp bed 2. It is believed that the application of shear to the networked pulp “shakes”, re-arranges or breaks up its structure and/or continuous contact between the networked pulp so that the pulp below the disturbance zone becomes more dense, which results in an enhancement of their settling rate and/or their packing density. Moreover, the disturbance is not so excessive as to cause fractionation of the networked pulp into smaller pieces, which settle more slowly. The relatively denser pulp tends to reform into a networked pulp layer below the disturbance zone, due to its own weight applying compaction forces to the pulp. As a result, the invention provides the appropriate amount of disturbance to increase the settling rate and/or underflow density of the pulp in the networked layer or pulp bed 2, thus leading to increased efficiency and performance of the separation device.

Where the shearing mechanism is mechanical agitation and uses a shearing device, the disturbance parameters in the invention can be reduced to specific shearing parameters. These shearing parameters comprise the shearing device speed (linear or rotational), the depth of the disturbance zone or shear region and the (three-dimensional) shearing device shape. This unexpected and surprising discovery means that the amount of shear applied to the pulp can be optimally controlled in accordance with operational requirements, especially variations in the supply of the suspension, whilst maintaining the improved separation efficiency in the separation device. In the case of a thickener, the application of the method results in improvements in the recovered underflow density of the settled pulp relative to the amount of flux or throughput of the liquid slurry that is processed by the thickener.

It will be appreciated by those skilled in the art that the concept of causing a disturbance, for example by applying shear, in a disturbance zone in the networked layer 2, is contrary to conventional thought and has not been contemplated as such in the prior art. In the prior art, it was preferred not to disturb the pulp bed 2 or the hindered zone 4, since most of the aggregates are compacted or almost compacted (in the case of the hindered zone 4), and improvements were focussed on improving the efficiency of the settling process, either in the feedwell 9 or in the free settling zone 6 in the tank 1. This was reflected in the design of thickeners specifically to minimise motion within the pulp bed 2. For example, equally spaced predominantly vertically extending pickets were mounted on the rake arms to create vertical dewatering channels to release liquid. However, the configuration and spacing of the pickets were designed to ensure that the pickets moved gently through the pulp bed 2 to minimise any turbulence created by the pickets or their associated dewatering channels. A further advantage of the invention is that disturbing the networked pulp layer 2 in the disturbance zone 16, for example by the application of shear, tends to inhibit the formation of donuts in the networked pulp layer.

The inventors have discovered that the disturbance, preferably by way of shear, induces a stepwise increase in the density of the pulp below the disturbance zone. In the context of the application of the invention to a thickening process, the inventors have found that by controlling the disturbance, preferably shear, to an optimal amount using at least one or more of three primary options that will be discussed in more detail below, this stepwise increase in density of the pulp below the disturbance zone is at least a 5% increase compared to the density of pulp above the disturbance zone. In one preferred form, there is at least a 10% increase compared to the density of pulp above the disturbance zone. In other preferred forms, the density of the pulp below the disturbance zone is at least 25%, preferably at least 35% and more preferably at least 50%, greater than the density of pulp above the disturbance zone.

It will be appreciated that during operation of the separation device, the depth of the networked pulp layer 2 will gradually increase. Alternatively, the separation device may have a relatively low networked pulp layer 2 for operational requirements. Consequently, the disturbance zone 16 may initially occupy a larger proportion of the networked pulp layer 2, and in such cases the disturbance zone may be within an upper 75% of the networked layer of pulp. Where a typical depth of the networked pulp layer is present in the tank, the disturbance zone is within an upper half of the networked layer of pulp. However, the method of the invention may still be implemented where the disturbance zone 16 is within an upper 30% of the networked layer of pulp, an upper 10% of the networked layer of pulp, or even at or adjacent the top of the networked layer of pulp.

Accordingly, a first embodiment of the invention is schematically illustrated in FIG. 2A. The method 20 for controlling shear applied to pulp within a separation device comprises the steps of introducing a feed material, typically a suspension comprising pulp, into a tank of the separation device at a flux (step 21), allowing the pulp to settle out of the feed material (step 22), disturbing the networked pulp in a disturbance zone of the networked pulp (step 23), and controlling one or more disturbance parameters to controllably apply an optimal disturbance to the networked pulp in the disturbance zone (step 24). This involves controlling the frequency of disturbance events (step 25), the depth of the disturbance zone (step 26) or both of these disturbance parameters, with respect to the flux and/or one or more operational parameters.

In particular, it has been discovered that an optimal disturbance is obtained by controlling one or more of the disturbance parameters in accordance with the following equation:

S₀=z.f₁(h).f₂(f).f₃(ρ) (1)
where S₀ is the optimal disturbance;
z is the frequency, or number of passes, of disturbance events in the disturbance zone within the predetermined period of time;
f₁(h) is the disturbance zone height or depth function;
f₂(f) is the flux function; and
f₃(ρ) is the operational parameter function.

In this case, only the frequency or number of disturbance events in the disturbance zone within the predetermined period of time is significant, not the quantum of each disturbance event or the sum of the quanta of those disturbance events.

The operational parameter function f₃(ρ) represents the one or more variable operational parameters of the separation device. These operational parameters typically comprise the pulp composition, the pulp particle size, the pulp flow velocity in the tank, the pulp yield stress, the pulp viscosity, the underflow specific gravity, the underflow weight per weight percentage and the rate at which flocculant is added to the suspension. As the operational parameter function f₃(ρ) can represent several variables, it is usually adjusted where one or more operational parameters are constant, or are assumed to be constant. For example, where the pulp viscosity or the underflow specific gravity is known and does not vary significantly over the operation of the separation device, the operational parameter function f₃(ρ) is then adjusted to f*₃(ρ) multiplied by a constant representing the known pulp viscosity or the underflow specific gravity value.

In this embodiment, the selected disturbance parameter(s) are kept proportional to the flux. That is, equation (1) becomes:

$${S}_{0} = \frac{z \times h \times {f}_{3} ( ρ )}{f} \qquad ( 2 )$$

where
S₀ is the optimal disturbance;
z is the frequency, or number of passes, of disturbance events in the disturbance zone within the predetermined period of time;
h is the disturbance zone height or depth function;
f is the flux function; and
f₃(ρ) is the operational parameter function.

Where all the operational parameters remain or are assumed to be constant, equation (2) becomes:

$${S}_{0} = \frac{z \times h \times {k}_{ρ}}{f} \qquad ( 3 )$$

where
S₀ is the optimal shear;
z is the frequency, or number of passes, of disturbance events in the disturbance zone within the predetermined period of time;
h is the height or depth of the disturbance zone;
f is the flux; and
k_{ρ} is a constant representing the operational parameters.

In the method 20, the frequency of disturbance events is initially set to a desired number and the disturbance zone depth is predetermined in relation to the flux to ensure that an optimal disturbance is applied to the networked pulp. Where the disturbance is caused by a physical device, the disturbance zone depth can controlled simply and directly by controlling the submersion of the disturbance causing device, since this will control the frequency of disturbance events to the networked pulp. Alternatively, the disturbance zone depth is controlled by controlling the level of the feed material or suspension in the tank, and thus the extent in which the disturbance causing device is submerged.

As the disturbance zone depth and the frequency of disturbance events are controlled through a suitable control unit or system of the separation device, it is relatively straightforward for these two disturbance parameters to be set at the same time to ensure that an optimal disturbance is applied to the networked pulp during operation of the separation device.

It will be appreciated from equations (1) to (3) that the optimal disturbance is a function of the disturbance parameters, operational parameters and the flux. Accordingly, the selected disturbance parameter(s) can be controlled with respect to one or more of the operational parameters of the separation device instead of the flux. The selected disturbance parameter(s) can also be controlled with respect to both the flux and the operational parameters.

Generally, the disturbing step 23 comprises the step of causing a disturbance substantially uniformly across the disturbance zone. By causing the disturbance substantially uniformly across the disturbance zone, the networked pulp in the disturbance zone is disrupted within a predetermined period of time, thereby releasing entrained liquid from the networked pulp in the disturbance zone and increasing the relative density of the pulp below the disturbance zone.

The disturbance is preferably at least present in the disturbance zone 16 for a period of time in which the networked pulp passes through the disturbance zone, from entry to exit. It is preferred that in practice the disturbance is caused continuously in the disturbance zone 16 during operation of the separation device over its work cycles to provide its advantageous and beneficial effects continuously for the entire period of the separation process. However, the disturbance may be limited to discrete time periods where desired.

It has been discovered that an advantageous implementation of the disturbing step 23 is to apply shear substantially uniformly across the disturbance zone 16. The mechanism by which shear is applied in the disturbing step 23 can take a number of forms. For example, one shearing mechanism is to use liquid or gas jets to inject a liquid or gas towards, into or through the disturbance zone 16 to apply shear substantially uniformly across the disturbance zone. Similarly, a fluidiser can direct fluid flow towards, into or through the disturbance zone 16 to apply shear substantially uniformly across the disturbance zone. Other shearing mechanisms include subjecting the disturbance zone 16 to mechanical vibration using a suitable vibratory apparatus or ultrasonic impulses to apply shear substantially uniformly across the disturbance zone. While these shearing mechanisms are suitable for implementing the disturbing (shearing) step 23 in the method of the invention, the inventors have determined that a preferred shearing mechanism is mechanical agitation, advantageously by way of a shearing device that moves through the disturbance zone 16 to apply shear substantially uniformly across the disturbance zone. In one preferred form, the shearing device is rotated in the tank in accordance with the disturbing (shearing) step 23.

A second embodiment of the invention is schematically illustrated in FIG. 2B, where corresponding features have been given the same reference numerals. The method 27 employs a shearing device to create disturbance in the disturbance zone 16 by applying shear through mechanical agitation. The method 27 is thus modified for the use of this particular shearing mechanism, and so the method 27 for controlling shear applied to pulp within a separation device comprises the steps of introducing a feed material (preferably by feeding a suspension comprising pulp) into a tank of the separation device at a flux (step 21), allowing the pulp to separate out of the suspension (step 22), submerging a shearing device for shearing pulp at least partially within a region of the tank (step 28), and controlling one or more shearing parameters to controllably apply an optimal shear to pulp passing through the disturbance zone or “shear” region (step 24). This involves controlling the shearing device speed (step 29), the depth of the disturbance zone or shear region (step 26), the three-dimensional shape of the shearing device (step 30), or any combination of these shearing parameters, with respect to the flux and/or one or more operational parameters.

In particular, it has been discovered that optimal shear is obtained by controlling one or more of the shearing parameters in accordance with the following equation:

S₁=f₁(h).f₂(f).f₃(ρ).f₄(λ).f₅(y) (4)

where
S₁ is the optimal shear;
f₁(h) is the disturbance zone/shear region height or depth function;
f₂(f) is the flux function;
f₃(ρ) is the operational parameter function;
f₄(λ) is the shear factor function; and
f₅(y) is the shearing device speed function.

As the shear factor λ is a variable representing the average shear applied to the aggregates by the shearing device, it is therefore a function of the three-dimensional shape and the shearing device speed. Consequently, the shearing device speed is both a shearing parameter and a factor influencing the shear factor λ.

Therefore, altering the three-dimensional shape of the shearing device will influence the optimal shear applied to pulp passing through the disturbance zone through the shear factor λ. The shearing device may alter its three-dimensional shape by having movable shearing elements that can adjust their angle of incidence with respect to the direction of movement of the shearing device. Alternatively, the shearing device may have shearing elements that can be added or removed during operation to change its three-dimensional shape. However, in most practical commercial applications the shearing device shape has a predefined shape for simplicity, as providing a shearing device with an adjustable shape adds complexity to the design. It is therefore contemplated that the shearing device speed and the disturbance zone depth will be commonly selected to comply with the above relationship expressed in equation (1) and obtain optimal shear.

In this embodiment, the selected shearing parameter(s) are kept proportional to the flux. That is, equation (4) becomes:

$${S}_{1} = \frac{λ \times y \times h \times {f}_{3} ( ρ )}{f} \qquad ( 5 )$$

where
S₁ is the optimal shear;
λ is the shear factor;
y is the speed of the shearing device;
h is the height or depth of the disturbance zone/shear region;
f is the flux; and
f₃(ρ) is the operational parameter function.

Where all the operational parameters remain or are assumed to be constant, equation (5) becomes:

$${S}_{1} = \frac{λ \times y \times h \times {k}_{ρ}}{f} \qquad ( 6 )$$

where
S₁ is the optimal shear;
λ is the shear factor;
y is the speed of the shearing device;
h is the height or depth of the disturbance zone/shear region;
f is the flux; and
k_{ρ} is a constant representing the operational parameters.

In the method 27, the shearing device speed is initially set to move at the required speed, and both the shearing device shape and the disturbance zone/shear region depth are predetermined, in relation to the flux to ensure that an optimal shear is applied to the pulp. The shear region depth is controlled simply and directly by controlling the submersion of the shearing device, as this will control the extent to which the shearing device will apply shear to the pulp. Alternatively, the shear region depth is controlled by controlling the level of the suspension in the tank, as thus the extent in which the shearing device is submerged. As discussed above, the shearing device shape is usually predefined, although it is possible to have shearing devices with movable or adjustable shearing elements that change the shearing device shape.

As the shear region depth and the shearing device speed are controlled through a suitable control unit or system of the separation device, it is relatively straightforward for these two shearing parameters to be set at the same time to ensure that an optimal shear is applied to the pulp during operation of the separation device.

It will be appreciated from equations (4) to (6) that the optimal shear is a function of the shearing parameters, operational parameters and the flux. Accordingly, the selected shearing parameter(s) can be controlled with respect to one or more of the operational parameters of the separation device instead of the flux. The selected shearing parameter(s) can also be controlled with respect to both the flux and the operational parameters.

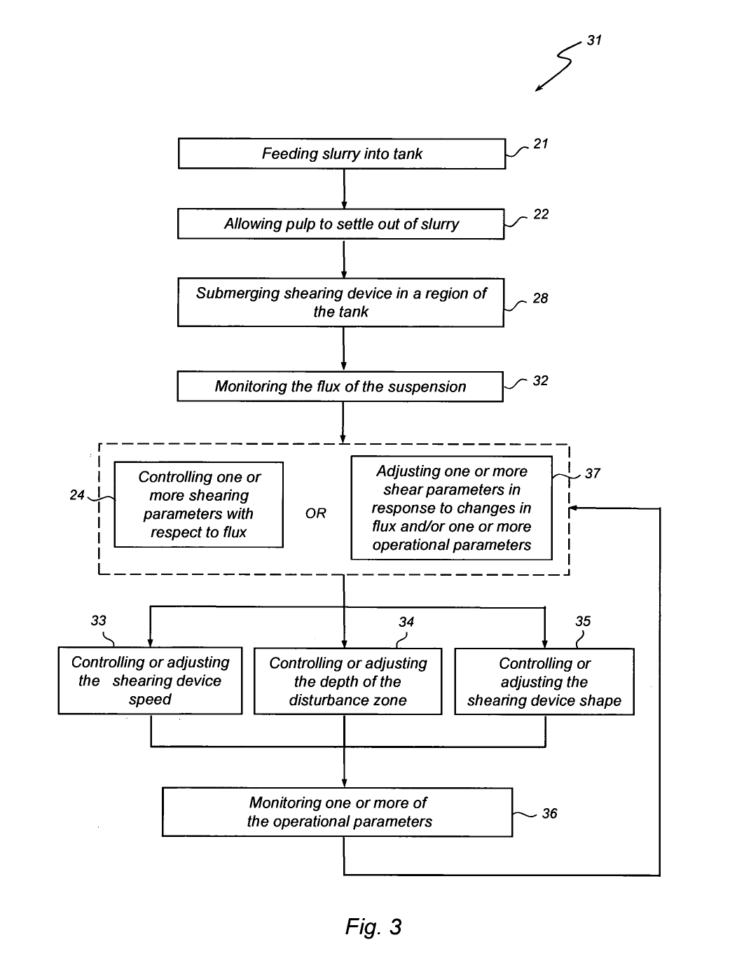

A particular advantageous embodiment is illustrated in FIG. 3, where corresponding features have been given the same reference numerals. The method 31 of this embodiment is applied to the settling process in a thickener, where at step 21a slurry containing a mixture of liquid and pulp aggregates or particles is fed into a thickening tank at an initial flux. At step 22, the pulp is then allowed to settle out of the slurry. At step 28, a shearing device is submerged within a region of the tank. It will be appreciated that the shearing device may be submerged within the region prior to the settling step 22.

The method 31 further comprises monitoring at step 32 the flux of the suspension during the feeding step 21, using a suitable sensor (not shown) in communication with a control unit or system (not shown) of the thickener. In response to the monitoring step, the control unit controls one or more of the shearing parameters relative to the flux, to apply an optimal shear to the pulp at step 24, being the shearing device speed (step 33), the depth of the disturbance zone/shear region (step 34), the three-dimensional shape of the shearing device (step 35), or any combination of these shearing parameters, to meet the above relationship expressed in equations (4), (5) or (6). At step 36, one or more of the operational parameters are monitored with corresponding sensors in communication with the control unit or system. In response to any change in an operational parameter, the control unit or system adjusts one or more of the shearing parameters at step 37 to maintain the relationship of equations (4) or (5). In addition, any changes in the flux detected at step 31 may prompt adjustment of one or more of the shearing parameters at step 37. This involves adjusting the shearing device speed (step 33), the depth of the disturbance zone/shear region (step 34), the three-dimensional shape of the shearing device (step 35), or any combination of these shearing parameters, to maintain the relationship to the changed flux and/or operational parameter(s) in equations (4) or (5). Thus, in this embodiment the shearing parameter(s) are adjusted in response to the flux of the incoming suspension and/or operational parameters so that optimal shear is applied to the pulp at all times.

The adjusted shearing parameter need not be the same parameter initially selected at step 24. For example, the shearing device speed may be controlled initially at step 33, but subsequently, the shear region depth is adjusted at step 34 to maintain its relationship to the flux, thus maintaining the optimal shear. It will also be appreciated that the method may be implemented by using any one of the shearing parameters while keeping the remaining shearing parameters constant. For example, the method can be limited to control and/or adjustment of the three-dimensional geometry of the shearing device, while the shearing device speed and the shear region depth are preset. In this example, the shearing device shape can be controlled and/or adjusted by adding or removing shearing arms or elements. Alternatively, it is contemplated that one or more shearing elements are movable to adjust their angle of incidence to the direction of rotation of the shearing device.

In addition, the flux monitoring step 32 or the operational parameter monitoring step 36 may be omitted where it is desired to only control or adjust the shearing parameters with respect to only the operational parameter(s) or the flux. However, those skilled in the art will recognise that the most accurate control of the shearing parameters is obtained by monitoring both the flux and the selected operational parameter(s). In addition, only one or some of the operational parameters can be selected for monitoring at step 36, as desired or where the other operational parameters are constant or are assumed to be constant.

It will also be appreciated that the flux monitoring step 32 and the operational parameter monitoring step 36 may also be implemented for the disturbance control method 20 of FIG. 2A.

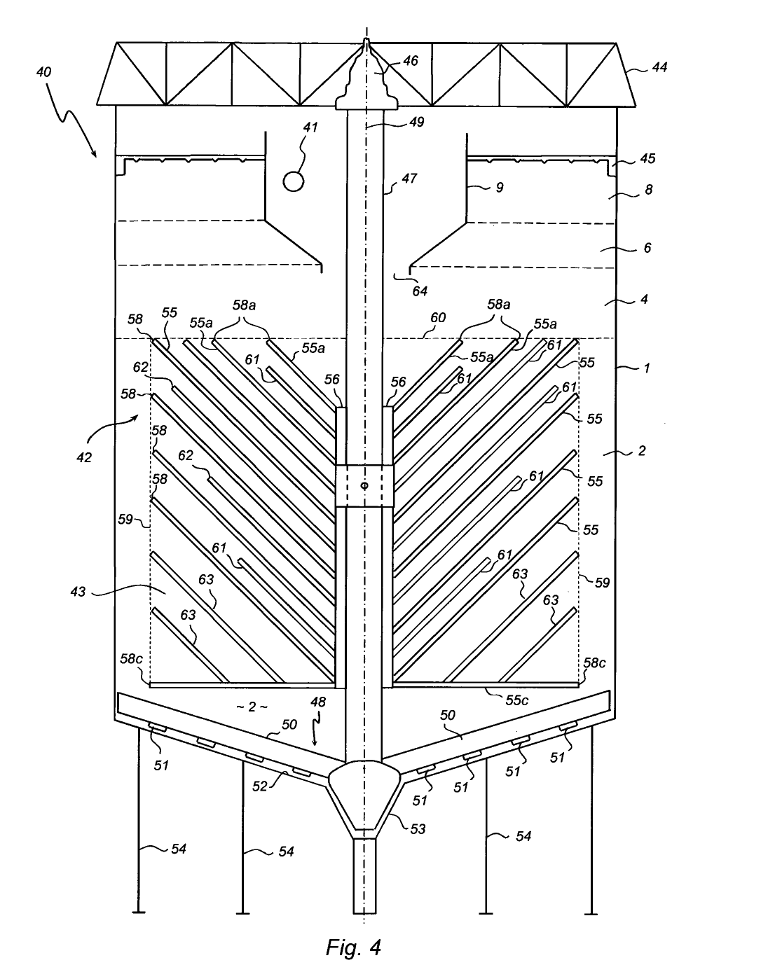

Referring to FIG. 4, a separation device in accordance with one embodiment of the invention is illustrated, where corresponding features have been given the same reference numerals. The separation device is in the form of a thickener 40 and comprises a tank 1, an inlet 41 for feeding the suspension at a flux into the tank via a centrally located feedwell 9, and a shearing device 42 for shearing pulp within the tank adapted for at least partial submersion within an upper “shear” region 43 of the pulp bed 2. One or more shearing parameters are controlled with respect to the flux and/or one or more operational parameters, to controllably apply an optimal shear to the pulp passing through the shear region/disturbance zone 43.

In this embodiment, the thickener 40 is configured as a bridge-type thickener, having a supporting bridge 44 located diametrically across and above the tank 1 and a circumferential overflow launder 45. A central drive assembly 46 operates a central drive shaft 47 to rotate a rake assembly 48 and the shearing device 42 about a central axis 49 of the tank 1. The rake assembly 48 comprises rake arms 50 having scraper blades 51 extending downwardly towards the bottom 52 of the tank 1 to move settled and compacted pulp towards an underflow outlet 53. The entire tank 1 is supported by columns 54.

The shearing device 42 comprises a plurality of radially outwardly extending shearing elements in the form of pickets 55 that are connected to parallel stems 56 from which the pickets extend at an angle inclination of approximately 45° to a vertical plane parallel to the central axis 49. The shearing device 42 also has a collar attachment 57 fixing the plurality of pickets 55 to the drive shaft 48. The pickets 55 are arranged in a tree-like array or structure so that their tips 58 are substantially in line with a vertical line 59. Four smaller pickets 55a are disposed at the top of the shearing device 42 so that the top two pickets 55a have their tips 58a substantially aligned with a horizontal plane 60 coincident with the boundary between the pulp bed 2 and the hindered zone 4, together with the uppermost of the pickets 55. A pair of lower horizontal pickets 55c terminate so that their tips 58c are substantially aligned with the vertical lines 59. Thus, the pickets 55 define a substantially rectangular shape having a width that substantially approximates to the diametrical cross-section of the thickener tank 1. A set of progressively shorter pickets 61 alternate between the longer pickets 55 with their respective tips 62 pointing upwardly. Additionally, supplementary pickets 63 extend parallel to the pickets 55 and 61 from the horizontal pickets 55c. The shorter pickets 61 and supplementary pickets 63 provide an increased number of shear events closer towards the rotational axis, where the linear velocity of the pickets is reduced.

In operation, a suspension of pulp in the form of a slurry is fed into the feedwell 9 through the inlet 41. The slurry may be fed tangentially into the feedwell 9 to improve the residence time for mixing and reaction with reagents, such as flocculants, that help create the aggregates or “flocs” of higher density pulp solids. Tangential entry also assists in dissipating the kinetic energy of the slurry in the feedwell 9, thus promoting settling within the tank 1. The suspension then flows downwardly under gravity out of a restricted outlet 64 into the tank 1, where it settles to form the various zones of material, including the pulp bed 2, hindered zone 4, free settling zone 6 and clarified zone 8. The relatively dense pulp bed 2 displaces the upper clarified zone 8 of relatively dilute liquor towards the top of the tank 1. The thickened pulp is drawn off through the underflow outlet 10, while the dilute liquor is progressively drawn off through an overflow launder 45.

As the depth of the pulp bed 2 increases to encompass the disturbance zone/shear region 43 as part of its upper region (around the upper 75% to 80% of the networked pulp layer 2), the shearing device 42 rotates around the tank 1, causing the pickets 55, 61 and 63 to apply an optimal shear force to the pulp aggregates or particles descending from the feedwell outlet 64 into the disturbance zone 43. As discussed above in relation to FIGS. 2B and 3, the shearing device speed, the depth of the disturbance zone/shear region 43, the three-dimensional shape of the shearing device 42, or any combination of these shearing parameters are controlled to maintain the relationship of equation (4), (5) or (6) with respect to the flux and/or one or more operational parameters. Furthermore, these shearing parameters, individually or in combination, are adjusted in response to changes in the flux and/or one or more operational parameters to ensure optimal shear is continuously applied to the pulp. This results in shear being applied in a sufficient amount to disrupt the networked pulp in the disturbance zone/shear region, thus releasing trapped liquid or liquor, and increasing the relative density of the pulp below the disturbance zone 43. The denser pulp below the disturbance zone 44 tends to reform a substantially higher density relative to the pulp above the disturbance zone, and thus settle quickly without excessive fractionation and detrimentally affect the settling process. The optimal shear is applied either as direct “hits” from the pickets 55, 61 and 63 or as disturbances in the zones of turbulence associated with the wake of the passage of the pickets 55 through the disturbance zone/shear region 43.

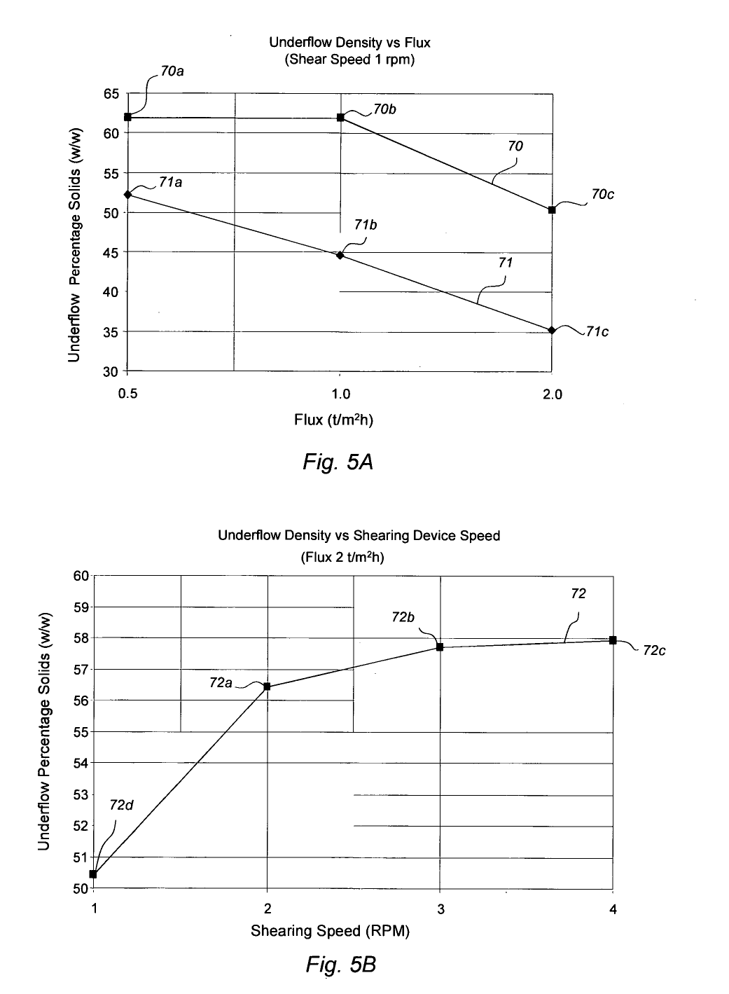

Referring to FIGS. 5A and 5B, the performances of the thickener of FIG. 4 and a conventional thickener having a rake assembly without any shearing device were graphed for comparison, based on results from laboratory scale thickener simulations. In FIG. 5A, the shearing device speed, disturbance zone/shear region depth and three-dimensional geometrical shape were fixed to test the methods of FIGS. 2B and 3 in respect of equations (4) to (6). This graph measures the underflow density of the settled pulp in the form of gold tailings as a percentage weight per weight against the flux of the suspension measured in tonnes per square metre hours (t/m²h), with the rotational speed of the rake assembly in the conventional thickener simulation and the rotational speeds of the rake assembly and shearing device 42 in the thickener simulation being the same at 1 revolution per minute (rpm). One skilled in the art will appreciate that the underflow density corresponds to the amount of recovered liquid overflow and mineral solids underflow from the feed slurry, and thus any percentage increase in the underflow density represent an improvement in the separation and settling process.

The results for the simulation of the thickener 40 are indicated by line 70, while the results for the conventional thickener simulation are indicated by line 71. As can be seen in FIG. 5A, the thickener 40 achieved significant increases in the underflow density of the gold tailings compared to the conventional thickener. In particular, where the ratio of the shearing device speed to the flux ratio was between 1:1 and 2:1, as indicated by data points 70a and 70b, the underflow density was approximately at its maximum level. That is, where the shearing device speed was 1 rpm and the flux was 0.5 t/m²h (and thus the shearing device speed to flux ratio was 2:1) an underflow density of approximately 62% w/w was obtained for gold tailings. Similarly, where the shearing device speed was 1 rpm and the flux was 1 t/m²h (and thus the shearing device speed to flux ratio was 1:1) an underflow density of approximately 62% w/w was also obtained for gold tailings. By way of contrast, in the conventional thickener for the same flux range and rake speed of 1 rpm, the underflow density decreased from approximately 52% w/w (data point 71a) to 45% w/w (data point 71b) as the flux increased from 0.5 t/m²h to 1 t/m²h. Thus, the thickener 40 was able to initially obtain an increase of 10% w/w in the underflow density at 0.5 t/m²h that subsequently increased to over 15% w/w as the flux increased to 1 t/m²h.

While the underflow density values dropped off in both the thickener 40 and the conventional thickener (as indicated by data points 70c and 71c, respectively) once the shearing device speed to flux ratio decreased below 1:1, the thickener 40 employing the method 27 continued to outperform the conventional thickener in underflow density. The inventors believe that this drop off in underflow density as the shearing device speed to flux ratio decreased indicates that an optimal amount of shear is required to maintain the improved separation efficiency from shearing the pulp, as per the method 27 of FIG. 2B. Thus, the thickener 40 employing the shearing device 42 achieved performance improvement over a shearing device speed to flux ratio of 2:1 to 1:1 and 1:2. Hence, an improvement in settling efficiency of between over 20% to over 33% was achieved in comparison to the conventional thickener in accordance with method 27.

This relationship between the shearing device speed and the flux is also illustrated in FIG. 5B, where the speed of the shearing device 42 in the thickener 40 was made variable so that its rotational speed could be adjusted relative to the flux of the suspension, to test equations (4), (5) and (6) in respect of the shearing device speed. The disturbance zone/shear region depth and three-dimensional shape of the shearing device were kept constant. This graph shows the underflow density of the same gold tailings used in FIG. 5A, as a percentage weight per weight against the shearing device speed in rpm, where the flux was kept constant at 2 t/m²h. The graph line 72 shows that as the shearing speed is increased from 1 rpm (data point 72d) to 2 rpm (data point 72a), there is a significant increase in underflow density. The graph line 72 also demonstrates that as the shearing device speed is increased from 2 rpm (data point 72a) there is a continued increase in underflow density to 3 rpm (data point 72b) up to 4 rpm (data point 72c). This represents a shearing device speed to flux ratio of 1:2 through 1:1 and 3:2 to 2:1. Thus, a significant improvement in the underflow density of gold tailings could be obtained by adjusting the shearing speed in response to changes in the flux, in accordance with the method 31 of FIG. 3.

In FIG. 5B, data point 72d, at a shearing device speed of 1 rpm, is the same data point as data point 70c of FIG. 5A. It is also noted that where the shearing device speed to flux ratio fell below 1:1, such as the flux being double the amount of the shearing speed (data point 70c in FIG. 5A and data point 72d in FIG. 5B), the underflow density was reduced. However, once the shearing speed was increased to be within the shearing device speed to flux ratio range of 1:1 to 2:1, the underflow density had optimally increased to approximately 56.5%, as indicated by data point 72a and further optimised to 58% w/w as indicated by data point 72c. It will be appreciated by one skilled in the art that FIGS. 5A and 5B demonstrate that when the shearing device speed to flux ratio was in the range of 1:1 to 2:1 a significant improvement in the underflow density was maintained across the range, whereas below that range there was too little shear to optimally affect the underflow density. Thus, it is clear from this discussion that the methods 20, 27 and 31, and equations (1) to (6) are valid.

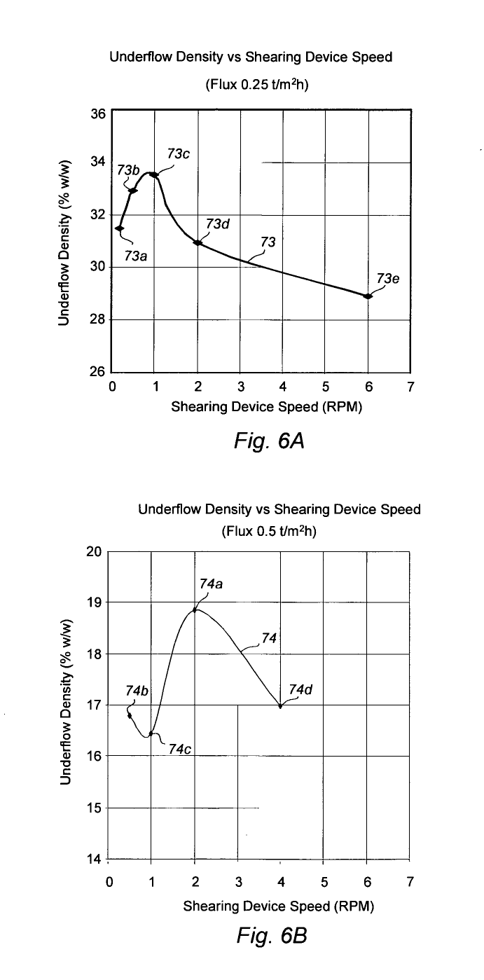

Referring to FIG. 6A, the performance of the thickener 40 of FIG. 4 was again simulated and graphed, substituting gold tailings with nickel laterite slurry as the suspension. In this performance test, the flux was kept constant at 0.25 t/m²h and the underflow density as a percentage weight per weight was measured against the variable shearing device speed in rpm. Again, the disturbance zone/shear region depth and three-dimensional shape of the shearing device were kept constant. Graph line 73 shows that the underflow density begins to increase when the shearing device speed is approximately 0.25 rpm at data point 73a (the shearing device speed to flux ratio being approximately 1:1) and continues to increase when the shearing device speed is approximately 0.5 rpm at data point 73b (the shearing device speed to flux ratio being approximately 2:1). The underflow density for nickel laterite continues to increase past the shearing device speed to flux ratio of 2:1 and reaches a peak when the shearing device speed is approximately 1 rpm at data point 73c, the shearing device speed to flux ratio being approximately 4:1. After the shearing device speed to flux ratio exceeds 4:1, the underflow density drops off, as indicated by data points 73d and 73e. Thus, there is a clearly optimal amount of shear that must be applied to the nickel laterite slurry to maintain the improved settling efficiency in the thickener 40, over the range of 1:1 to 6:1 for the shearing device speed to flux ratio, optimally a ratio of approximately 4:1.

Referring to FIG. 6B, where corresponding features have been given the same reference numerals, the thickener 40 operates the shearing device 42 at different speeds with the flux of the nickel laterite slurry kept constant at 0.5 t/m²h. The graph line 74 demonstrates that the underflow density reaches a peak value when the shearing device speed is at 2 rpm at data point 74a, where the shearing device speed to flux ratio is 4:1. Deviations from the shearing device speed to flux ratio of 4:1 below or above show that the underflow density correspondingly falls as indicated by data points 74b and 74c and data point 74d, respectively.

These performance tests show that, overall, as the flux doubles, the optimal shearing device speed should at least also be doubled to maintain optimal thickening performance. Thus, these tests demonstrate the functional relationship between the shearing device speed and the flux in obtaining optimal shear in accordance with equations (4) to (6), especially the proportional relationship of equation (5), where the other shearing parameters and operational parameters are kept constant.

The inventors have also found that the optimal ratio of shearing device speed to flux is a function of the size of the tank (ie. diameter) in which separation occurs. Hence, the optimal ratio has to be established for the particular tank size employed in the separation process to obtain the appropriate ratio for the proportional relationship between the shearing device speed and the flux.

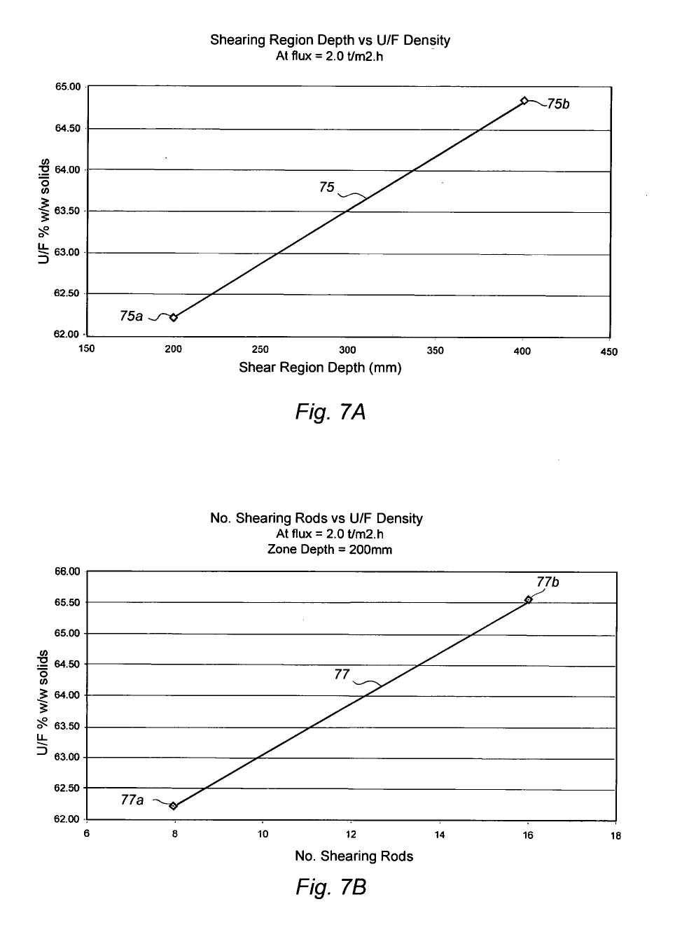

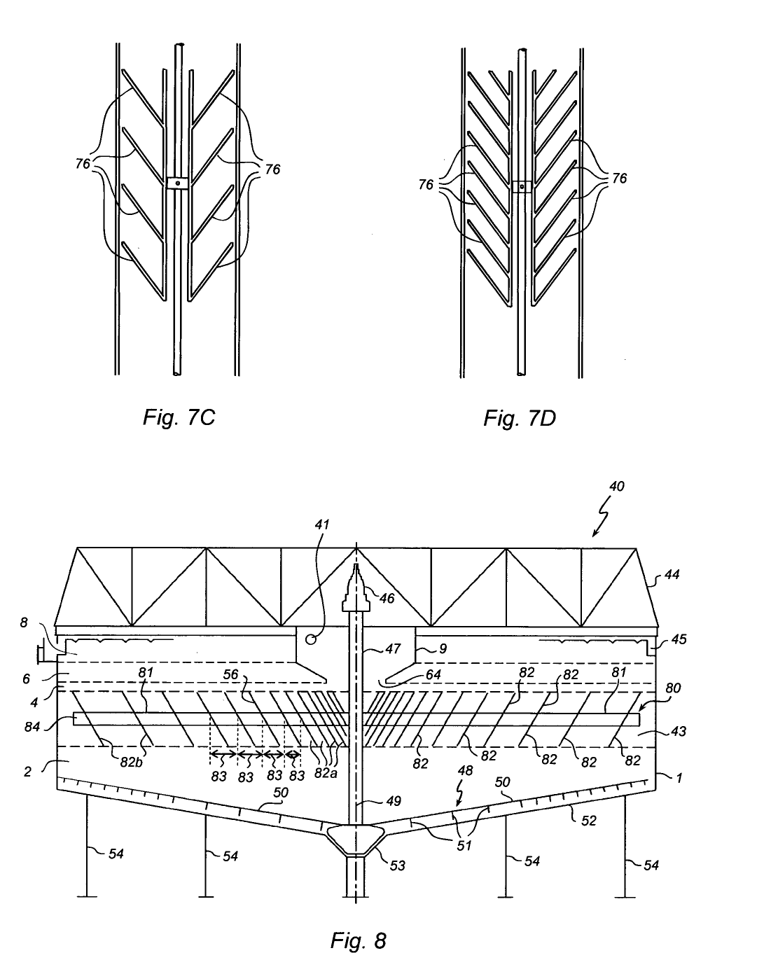

Another performance test was conducted based on results from laboratory scale thickener simulations where the shearing region depth of the shearing device 42 was variable, as shown in FIG. 7A. In the graph, the flux was fixed at 2.0 t/m²h and the rotational speed of the shearing device 42 was fixed at 2 rpm. While the three-dimensional geometrical shape of the shearing device 42 was fixed, the picket length was adjustable so that the disturbance zone/shear region depth changed from 200 mm to 400 mm. As shown by the graph line 75, the underflow density increased from approximately 62.25% at a shear region depth of 200 mm (data point 75a) to almost 65.00% at a shear region depth of 400 mm (data point 75b), thus increasing thickener performance.

This performance test also demonstrates the same functional relationship between the disturbance zone/shear region depth and the flux in obtaining optimal shear, where the other shearing parameters and operational parameters are kept constant, thus proving the methods 20, 27 and 31, and equations (1) to (6).

A further performance test was conducted based on results from laboratory scale thickener simulations, where the three-dimensional geometrical shape was varied, as shown in FIGS. 7B to 7D. In the graph of FIG. 7B, the flux was fixed at 2.0 t/m²h, the rotational speed of the shearing device 42 was fixed at 2 rpm and the disturbance zone/shear region depth was kept constant at 200 mm. The three-dimensional geometrical shape of the shearing device initially had eight pickets 76, as best shown in FIG. 7C. The number of pickets 76 in the shearing device was then doubled to sixteen pickets, as best shown in FIG. 7D, thus changing its three-dimensional geometrical shape. As shown by the graph line 77, the underflow density increased from approximately 62.25% for eight pickets (data point 77a) to just over 65.50% for sixteen pickets (data point 77b), thus increasing thickener performance.

This performance test demonstrates the same functional relationship between the three-dimensional shape of the shearing device and the flux in obtaining optimal shear, where the other shearing parameters and operational parameters are kept constant, thus proving the methods 20, 27 and 31, and equations (1) to (6).

As a consequence of these performance tests, the inventors conclude that employing the method 20 of FIG. 2A, especially the methods 27 and 31 of FIGS. 2A, 2B and 3, respectively, will result in an optimal shear being applied to the pulp that is consistently maintained to ensure the same level of improvement in the overall performance of a thickener employing a shearing device.

The inventors have found that in the invention the shearing parameters of the shearing device speed, disturbance zone/shear region depth and shearing device shape tend to dominate the relationship with the flux over the other possible operational parameters (for example, the pulp composition, the pulp particle size, the pulp flow velocity in the tank, the pulp yield stress, the pulp viscosity, the underflow specific gravity, the underflow weight per weight percentage and the rate at which flocculant (if any) is added to the suspension) to achieve an optimal shear profile. However, it is conceivable to apply the invention so that the shearing parameters are controlled in relation to the one or more of the operational parameters instead of the flux. In practice, the shearing parameters are controlled in relation to the flux and the operational parameters, so that these operational parameters are used to further adjust the shearing parameters of shearing device speed, disturbance zone/shear region depth and shearing device shape, to further enhance the application of optimal shear to the pulp.

In addition, the specific configuration of the shearing device does not directly affect the optimal shear profile that is obtained from the shearing device speed to flux ratio, provided that the shearing device is configured to apply a shear to the pulp in the hindered zone, pulp bed or both. It will be appreciated that the invention can thus be implemented to any shearing device employed in a separation device, and so is not limited to a particular shearing device configuration. The inventors have, however, determined that there are several preferred configurations for the shearing device as they are generally more efficient in achieving an optimum shear profile, which are described below.

Thus, the inventors have discovered that the optimal amount of shear that results in improved and optimal thickener performance can be achieved primarily where the shearing device configuration results in at least one of, or a combination of, the following:
(1) a substantially uniform cumulative shear being applied to the networked pulp in the disturbance zone within the predetermined period of time;
(2) a substantially uniform average shear being applied to the networked pulp in at least two intervals between shearing elements spaced apart along at least one arm of the shearing device, along a line parallel to or coincident with the at least one arm; and
(3) a substantially uniform number of shear events being applied to the networked pulp in the disturbance zone within the predetermined period of time.

The separation device 40 of FIG. 4 has a shearing device 42 that employs the concept of substantially uniform cumulative shear, which is discussed in more detail below.

If a pulp aggregate or particle is settling at a distance l from the centre at a rate ν m s⁻¹, and the depth of the disturbance zone is d m, then the time taken by the particle to move through the disturbance zone is represented by

θ=d/ν seconds (7)

Assuming that there are, for example, four sets of rotating outwardly extending shearing elements in the form of angled pickets mounted on a centre shaft travelling at a rotational speed of co revolutions per second, the number of “passes” in time θ is represented by:

n=4.θω (8)

This number of passes can also be regarded as the number of shear “events” experienced by each pulp aggregate or particle as the shearing pickets move past. In this context, the shear applied by any individual picket not only includes a direct “hit” of the pulp aggregate by the picket but the disturbance or “shaking” of the pulp aggregate caught in the wake of the passage of the picket, which the inventors call a “zone of turbulence”. These zones of turbulence are sufficient to apply a shear force to the aggregate or pulp particle, albeit less than the amount of shear directly applied by the pickets.

Thus, in the shearing picket configuration of FIG. 4, the probability of a pulp aggregate or particle being subjected to varying shear rates during the n shearing events is greater for the configuration of FIG. 4 than a configuration where the pickets are substantially vertically extending, assuming that the number of shear events is significantly greater than 1. Hence, the total shear applied to a layer of settling pulp aggregates or particles becomes more uniform as n increases and the angle of the pickets φ is increased. However, the inventors believe that increasing φ several degrees beyond 45° is not beneficial because of fluid flow considerations, and substantially uniform cumulative shear is optimally obtained by inclining the shearing elements at 45° to the vertical.

With reference to the embodiment of FIG. 4, in operation the shearing device 42 is rotated about the central axis 49 by the central drive shaft 47 to apply a substantially uniform cumulative shear to the pulp passing through disturbance zone 43 of the pulp bed 2 in accordance with principles described above. That is, shearing device 42 makes several passes through the disturbance zone 43 and the pickets 55, 61 and 63 are angled so that the pulp aggregates or particles are subjected to several varying shear events, either by way of a direct “hit” or being caught in a zone of turbulence, as indicated by equations (7) and (8). The shorter pickets 61 and supplementary pickets 63 provide an increased number of varying shear events closer towards the central axis 49, where the linear velocity of the pickets is reduced. Thus, the cumulative shear applied to pulp exiting the region 43 is substantially uniform or the same.

Additionally, the inventors have discovered that where the shearing device comprises a plurality of shearing elements spaced apart along at least one arm to define intervals therebetween, an optimal amount of shear is obtained by providing a substantially uniform average shear in at least two intervals along a line parallel to or coincident with the at least one arm, and more preferably all the intervals between the shearing elements along the line.

In most cases, the shearing device will employ two or more outwardly extending radial arms and thus the substantially uniform average shear applied in the intervals between the shearing elements will be along a radial line in alignment with the radial arms. In other words, the line along which the substantially uniform average shear is applied in the intervals generally corresponds to the profile of the shearing device when viewed in plan. However, it will be appreciated that where the shearing device is partially or fully non-linear in cross-section, the line will correspondingly be partially or fully non-linear in conformity with that cross-section of the shearing device. For example, the shearing device may have arms that are sinuous, partially curved or even zigzag like in shape, in which case the substantially uniform average shear would be applied along a sinuous, partially curved or even zigzag like line, respectively.

This concept of applying a substantially uniform average shear is discussed in more detail below with reference to FIG. 8, which illustrates another embodiment of the invention where corresponding features have been given the same reference numerals. In this embodiment, the thickener 40 has a shearing device 80 comprising two outwardly extending radial arms 81, with a plurality of shearing elements in the form of angled linear rods or pickets 82 mounted to each radial arm. The pickets 82 are inclined at an angle of approximately 45° with respect to a vertical plane and are spaced at uneven intervals 83 to each other, with the pickets progressively decreasing in number from an axis of rotation 49 to respective outer edges 84 of the radial arms 81. This progressive increase in the intervals 83 is in proportion to the distance of their associated pickets 82 from the axis of rotation 49. As a result, the inner pickets 82a are densely located relative to each other towards the rotational axis 49, compared to the outer pickets 82b near the outer edges 84.

The uneven spacing of the pickets 82 along the radial arms 81 results in the average shear in the intervals 83 between each pair of pickets 82 being substantially the same or uniform along a radial line defined by the radial arms 81. In particular, the inventors have determined that the shear applied to pulp aggregates or particles is generally a function of the linear speed or velocity of the pickets (or other shearing elements) and the distance between the picket and the pulp aggregate or particle. Since the linear velocity of the picket is also a function of the rotational speed of the drive shaft and the distance of the picket from the axis of rotation, the inventors have determined that as the distance from the axis of rotation increases, the linear velocity of the picket increases proportionately.

The shear rate applied to a pulp particle or aggregate by a moving picket is generally expressed by:

[symbol]

=k.uₗ/ξ (9)

where
[symbol] is the shear rate in s⁻¹,
uₗ is the linear velocity of the picket in ms⁻¹,
ξ is the distance between the picket, and the pulp aggregate or particle in metres, and
k is a constant, which is a function of material properties of the pulp.

Also,

uₗ=2πω.l (10)

where
ω is the rotational speed of the shaft in s⁻¹; and
l is the distance from the centre in metres.

Equations (9) and (10) indicate that as the distance l from the axis of rotation 49 increases, the linear velocity of the picket 82 increases proportionally as uₗ is a product of 2πω and l. For a set of particles (or aggregates) between any two pickets 82, in order to ensure that the average shear is substantially the same or uniform along the line parallel or coincident with the radial arms (ie. along the length of the radial arm 81), the spacing (ξ) between the pickets and the aggregates needs to increase proportionally to the linear velocity. That is, the distance or gap between the pickets 82 is in proportion to their distance l from the axis of rotation 49 along the radial arm 81. Hence, the requirement for a substantially constant or uniform average shear can be met by increasing the distance or gap between the pickets in proportion to their distance along the radius. By way of contrast, this substantially constant or uniform average shear cannot be achieved by means of a set of evenly spaced pickets or rods fixed to a radial arm, since the linear speed of any such rod is proportional to its distance from the centre.

The configuration of the shearing device 80 results in a substantially uniform cumulative shear being applied to networked pulp exiting the upper shear region 43 and a substantially uniform average shear being applied in the intervals 83 between the pickets 82 along a radial line defined by the radial arms 81. Specifically, the shearing device 80 makes several passes through the region 43 and the pickets 82 are angled so that the pulp aggregates or particles receive several varying shear events is increased, either by way of a direct “hit” or being caught in a zone of turbulence. Thus, the cumulative shear applied to pulp exiting the region 15 is substantially uniform or the same.

In addition, the outer pickets 82b provide a higher shear force than the inner pickets 82a due to the outer pickets 82b having a greater linear velocity, as indicated by equations (9) and (10). However, due to the denser distribution of the inner pickets 82a compared to the outer pickets 82b, aggregates closer towards the axis of rotation 49 of the shearing device 80 have a more uniform shear profile over a smaller range of shear (in the amount of shear) than that applied to aggregates further from the axis of rotation 49. The shear profiles in the intervals 83 toward the outer edges 84 of the radial arms 81 are relatively less uniform and extend over a larger range or amplitude of shear than the shear profiles closer towards the axis of rotation 49. However, due to the differential spacing, the average shear applied to the pulp aggregates in the intervals 83 defined between the pickets 82 will be substantially uniform across the radial arms 81.

Thus, both the cumulative shear from the total number of shear events and the average shear between the pickets 82 are each substantially uniform (although not generally the same value) due to the arrangement of the angled pickets 82 on the radial arms 81. This causes the “shaking”, re-arrangement or break-up of pulp aggregates to release trapped liquid, improving the overall density of the pulp bed 2, and to create denser aggregates that settle quickly in the pulp bed 2, thus improving the separation efficiency.

Furthermore, the inventors have unexpectedly discovered that the application of a substantially uniform number of shear events across the disturbance zone 16 will also achieve an optimal shear profile that disrupts the networked pulp, thereby releasing trapped liquid 14 and increasing the density of the pulp 18 below the disturbance zone. The inventors have discovered that so long as the number of shear events received by the pulp passing through the disturbance zone 16 is substantially uniform over a predetermined period of time (for example, the period it takes for an x number of revolutions), then shear is being applied substantially uniformly across the disturbance zone, as indicated by equation (8). Thus, the necessary disruption to the networked pulp is obtained, along with the associated release of trapped liquid 14 and increase in the density of the pulp 18 below the disturbance zone 16. It follows that a uniform number of shear events does not require substantially uniform cumulative shear or substantially uniform average shear to be applied at the same time, since the number of shear events is significant and not the amount of each shear event.

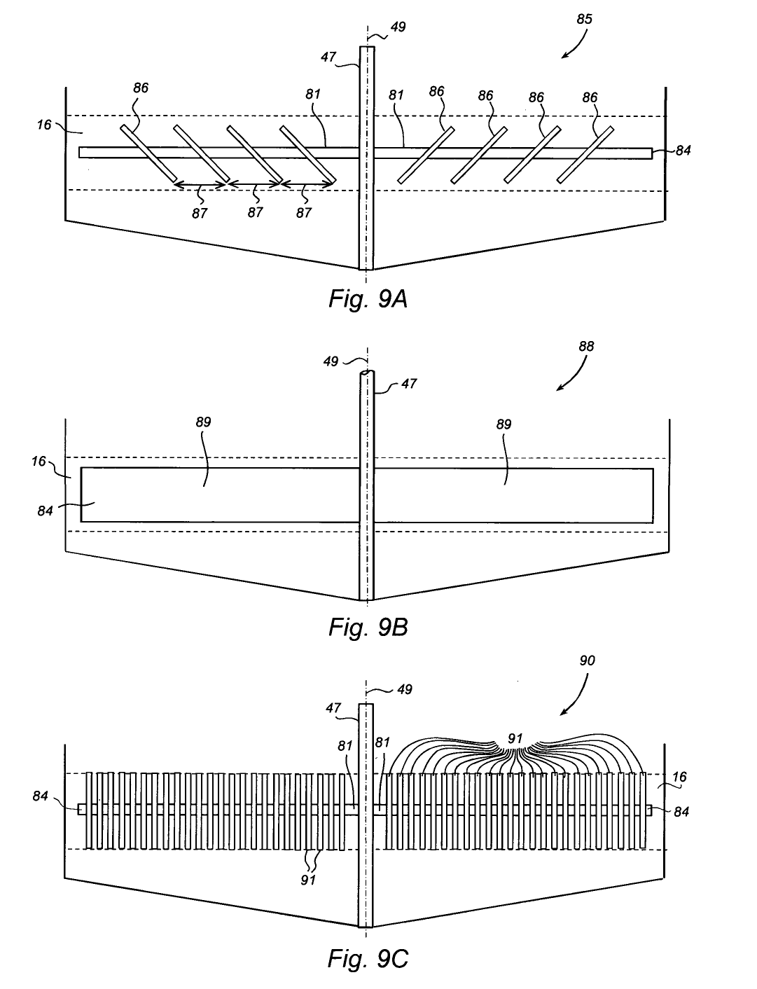

Accordingly, FIGS. 9A, 9B and 98C illustrate shearing devices that achieve a uniform number of shear events without applying substantially uniform cumulative shear or substantially uniform average shear.

In FIG. 9A, where corresponding features have been given the same reference numerals, the shearing device 85 has two outwardly extending radial arms 81, with a plurality of shearing elements in the form of angled linear rods or pickets 86 mounted to each radial arm. The pickets 86 are inclined at an angle of approximately 45° with respect to a vertical plane and are spaced at even intervals 87 to each other from an axis of rotation 49 to respective outer edges 84 of the radial arms 81. The shearing device 85 makes several passes through the disturbance zone 16 and the pickets 86 are angled so that the networked pulp aggregates 13 or particles 12 receive the same number of shear events between entry and exit of the pulp into and out of the disturbance zone 16. However, the even spacing of the pickets 86 means that the average shear in the intervals 87 between each pair of pickets 86 is not the same or uniform along a radial line defined by the radial arms 81. In addition, as the pickets 86 are not arranged to compensate for the progressive increase in linear velocity of the pickets 86 towards the outer edges 84 of the radial arms 81, and thus the amount of shear, then the cumulative amount of shear is not the same of uniform.

Similarly, in FIG. 9B, where corresponding features have been given the same reference numerals, the shearing device 88 has two outwardly extending radial shearing arms 89 that apply shear across their respective lengths, and thus substantially uniformly across the disturbance zone 16. As there are no shearing elements other than the radial arms 89 that occupy the depth of the disturbance zone 16, there are no intervals for average shear nor any way to compensate for the progressive increase in linear velocity of the shearing arms 89 towards their respective outer edges 84.

In FIG. 9C, where corresponding features have been given the same reference numerals, the shearing device 90 has two outwardly extending radial arms 81, with a plurality of shearing elements in the form of substantially vertical linear rods or pickets 91 mounted to and equispaced along each radial arm. In this embodiment, the pickets 91 are grouped closely together in a tight concentration to increase the area of the disturbance zone 16 to approximately 50% of the cross-sectional area of the upper region 17, and hence 50% of the networked pulp in the upper region, that receives a shear event during a pass of the shearing device 90. The shearing device 90 makes several passes through the disturbance zone 16 and the concentration of pickets 91 ensures that 50% of the networked pulp aggregates 13 or particles 12 receive the same number of shear events between entry and exit of the pulp into and out of the disturbance zone 16. As the pickets 91 are equispaced along the radial arms 81, there is no uniform average shear between each pair of pickets 91 along a radial line defined by the radial arms 81. In addition, the pickets 91 are not arranged to compensate for the progressive increase in linear velocity of the pickets 91 towards the outer edges 84 of the radial arms 81, and hence, the amount of shear. Consequently, the cumulative amount of shear is not the same or uniform. In one variation, another set of radial arms 81 are provided with pickets 91 offset to the pickets 91 on the first set of radial arms 81 to apply shear in the intervals and thus increasing the disturbance zone 16 to encompass the entire upper region 17 (100%), and thus apply shear to the entire (100%) networked pulp passing through the upper region.

It has also been determined that an optimal shear can be obtained by either providing a substantially uniform cumulative shear, a substantially uniform average shear between the shearing elements or a substantially uniform number of shear events independently of each other, or a combination of any two or all three.

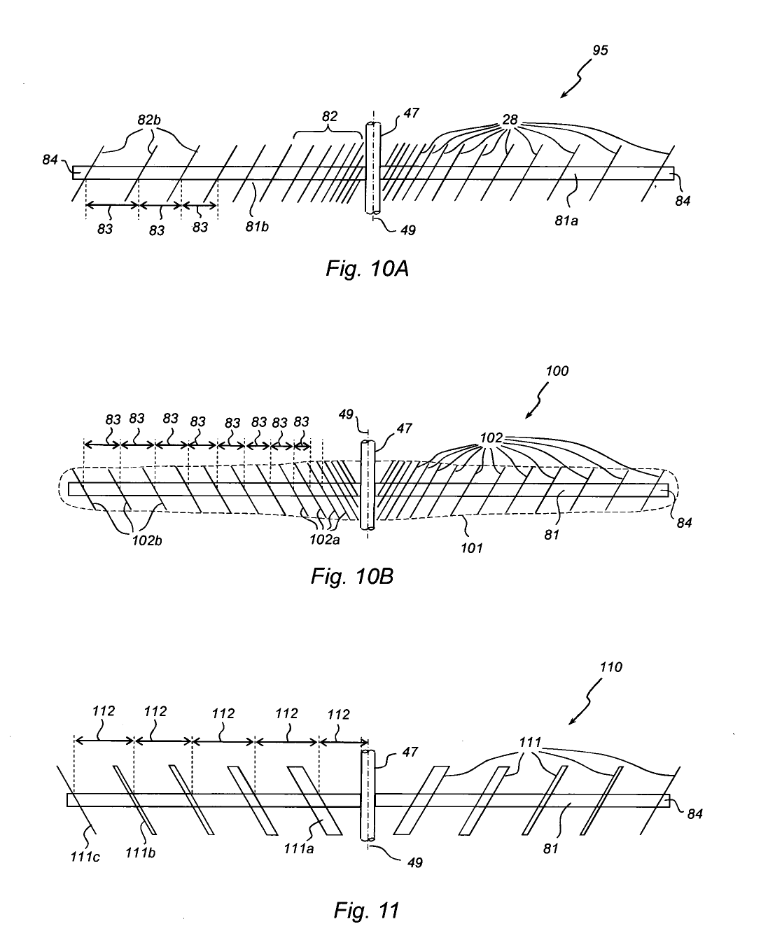

Additional non-limiting examples of shearing devices for use in the method and separation device of the invention are briefly discussed below in relation to FIGS. 10A to 22B, where corresponding features have been given the same reference numerals. In each of these embodiments, the shearing devices operate substantially the same way as described in relation to the embodiments of FIGS. 4 and 8, unless otherwise indicated.

In FIG. 10A, the shearing device 95 has angled pickets 82 arranged in an asymmetrical configuration with respect to the axis of rotation 49. The inventors believe that the asymmetric configuration or array further increases the probability of pulp aggregates or particles experiencing multiple varied shear events when passing through the disturbance zone 43 to provide a substantially uniform cumulative shear, in addition to the angling of the pickets 82 at approximately 45° with respect to a vertical plane perpendicular to the radial arm 81 at the respective point of connection. This is because the pickets on one radial arm 81a will apply shear to a different part of the disturbance zone 43 to the pickets 82 on the other radial arm 81b. The pickets 82 are also spaced at uneven intervals 83 that progressively increase in proportion to the distance of their associated pickets from the rotational axis 49 to the outer edges 84 of the radial arms 81 so that the average shear in the intervals 83 between the pickets 82 is substantially the same. This results in the number of pickets 82 progressively decreasing from the central axis 49 to the outer edge 84 of each radial arm 81.

In FIG. 10B, the shearing device 100 has a tapered profile 101 that is defined by angled pickets 102 of differing lengths, together with the radial arms 81. The pickets 102 progressively decrease in length from the axis of rotation 49 to the respective outer edges 84 of the radial arms 81. By progressively reducing the length of the pickets 102 at the outer edges 84, the shearing device 100 reduces the amount of shear applied by the outer pickets 102b. In this embodiment, the shearing device 100 provides a substantially uniform cumulative shear but does not provide a uniform average shear in the intervals between the pickets 102 along a radial line, because the pickets 102 have been spaced at intervals 83 to compensate for their reduced length. While this results in the average shear varying between the pickets 102, the cumulative shear from this picket configuration is substantially uniform, since the increased shear due to the additional pickets 102b at the outer edges counterbalances the reduction in picket length.

In FIG. 11, the shearing device 110 has pickets 111 that vary in thickness and are spaced at intervals 112. Since the shape of the pickets dictates the amount of shear applied to the pulp aggregate, a picket with an increased width will produce a higher amount of shear than a picket having a smaller width. Therefore, in this embodiment, the pickets 111 progressively decrease in thickness from the rotational axis 49 to the outer edges 84, with the inner pickets 111a having a greater thickness or width compared to the outer pickets 111b and 111c. Thus, the shearing device 110 provides a substantially uniform cumulative shear to the pulp exiting the disturbance zone or shear region 43. Moreover, uniform average shear can be obtained in the intervals 112 between the pickets 111 by suitably progressively decreasing their thickness from the central axis of rotation 49 to the outer edges 84.

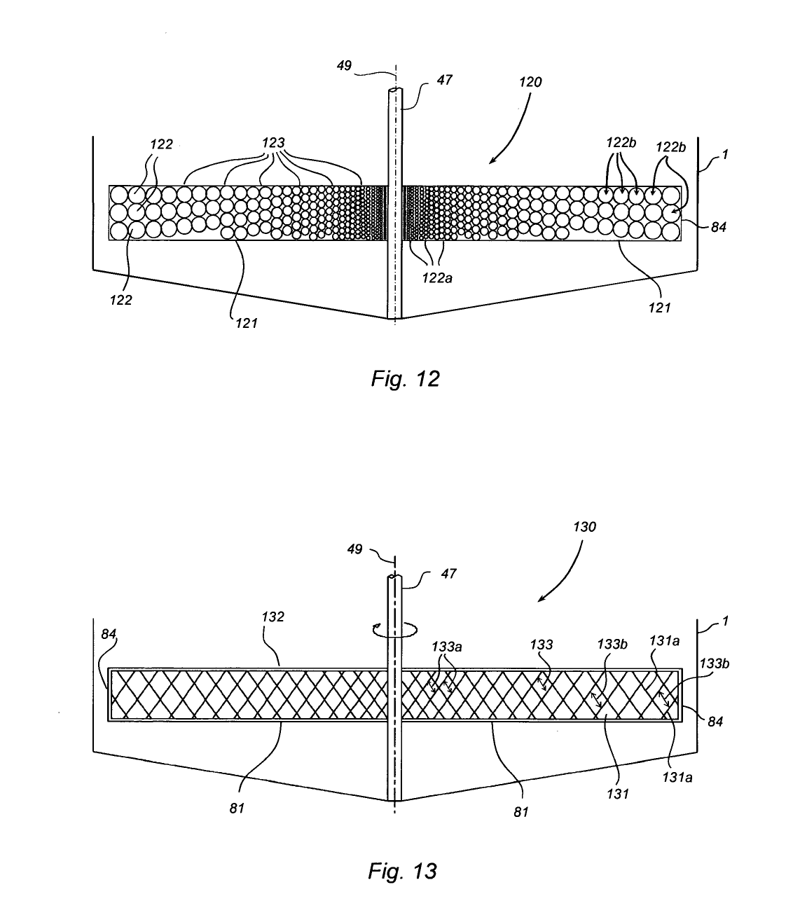

Referring to FIG. 12, the shearing device 120 comprises two substantially vertical plates 121 each having a series of holes or apertures 122 that are substantially aligned vertically in “columns” 123. Unlike other previously described shearing devices, the holes 122 apply shear to the pulp passing through the region 43. This is because the movement of the plates 121 causes the pulp aggregates or particles to be forced or “squeezed” through the holes 122, thus resulting in the pulp aggregates or particles experiencing a shear force applied by the edges of the holes 46 and a more concentrated distribution of shear within the smaller holes 46a. In addition, the holes or apertures 122 progressively increase in diameter from the axis of rotation 49 to the respective outer edges 84 of the plates 121 to provide the substantially same effect as the less dense distribution of the outer pickets 82b in the shearing device of FIG. 8. In this case, the smaller holes 46a toward the rotational axis 29 travel at a lower velocity compared to the larger holes 46b toward the outer edges 31, but have a more concentrated distribution of shear than the larger holes 46b due to their smaller diameter.

Thus, as the shearing device 120 rotates, the pulp particles or aggregates closer to the axis of rotation 49 experience a more uniform series of shear events that vary over a smaller range or amplitude of shear than the pulp aggregates or particles at the outer edges 84 of the shearing plates 121 due to the higher number, decreased size and lower linear velocity of the inner holes 122a. The increased areas of the outer holes 122b are designed to offset their increased linear velocity at the outer edges 84 compared with the lower linear velocity of the smaller inner holes 122a. Hence, the outer holes 122b provide a less uniform shear profile over a larger range or amplitude of shear compared to the shear profile applied by the inner holes 122a to aggregates closer towards the axis of rotation 49. In other words, the size of the holes 122 progressively increases from the rotational axis 49 to the outer edges 84. Thus, the shearing device 120 provides a substantially uniform cumulative shear to the pulp exiting the disturbance zone/shear region 43.

It will be appreciated that the holes 46 need not be organised in regular columns 123, but can be arranged in other configurations. For example, the holes 122 could be aligned at an angle to the vertical to define angled columns or even randomly arranged provided that the hole diameter progressively increases towards the outer edges 84. In one particular variation, the diameter size of the holes 122 can be suitably adjusted to obtain uniform average shear in the intervals as defined by the respective diameters of the holes, namely by ensuring that the progressively larger holes are located in proportion to their distance from the axis of rotation 49. In another variation, the diameter size of the holes 122 are substantially the same or uniform, thus resulting in a substantially uniform number of shear events being applied to the networked pulp in the disturbance zone.

Referring to FIG. 13, the shearing device 130 is formed with a mesh 131 having a diamond pattern, structurally supported by a border 132 defining the outer perimeter of the mesh. The spacing or interval 133 between each mesh element 131a progressively increases in proportion to the distance of their associated mesh elements from the axis of rotation 49 to the outer edges 84 such that the inner intervals 133a are less than the outer intervals 133b, thus achieving a similar effect as the uneven intervals 83 between the pickets 82 in the shearing device of FIG. 8. The inventors have found that both the cumulative shear applied by the shearing device 130 and the average shear in the intervals 133 between each part of the mesh 131 are each separately substantially uniform. It will be appreciated that other patterns can be used for the mesh 131, for example, hexagonal, octagonal and other polygonal shaped patterns or even combinations of polygonal shapes, whether regular or randomised. The inventors have found that both the cumulative shear applied by the shearing device 130 and the average shear in the intervals 133 between each part of the mesh 131 are each separately substantially uniform.

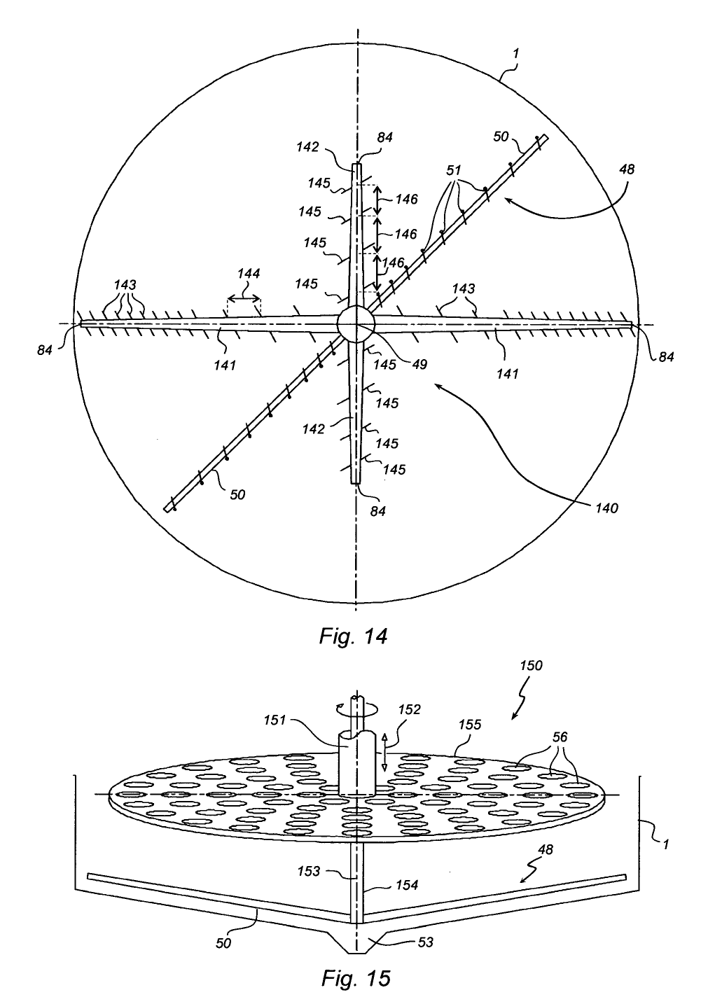

Referring to FIG. 14, the shearing device 140 is formed with two pairs of radial arms, one pair of radial arms 141 being longer than the other pair of radial arms 142. The picket configuration on the radial arms 141 has a tapered profile due to the progressively decreasing length of the angled pickets 143 and is arranged asymmetrically about the axis of rotation 49. However, unlike any of the previous embodiments, the number of pickets 143 progressively increases from the central axis of rotation 49 to the respective outer edges 84 as the uneven intervals 144 progressively decrease. The other pair of radial arms 142 have pickets 145 arranged asymmetrically about the axis of rotation 49, although at even intervals 146 rather than uneven intervals so that the pickets 145 apply shear in the intervals 144 between the pickets 143 of the longer radial arms 141. This increases the probability of the pulp aggregates or particles experiencing several shear events as they pass through the disturbance zone 43 of the pulp bed 2. As a result, it is believed that the second pair of radial arms 142 enhances the substantially uniform cumulative shear effect, as does the use of different configurations for the plurality of pickets on the respective pairs of radial arms 141 and 142.

As a result, neither the longer radial arms 141 nor the shorter radial arms 142 individually provide a uniform cumulative shear. However, the second pair of radial arms 142 is arranged to compensate for the first pair of radial arms 141 so that the shearing device 140 achieves a substantially uniform cumulative shear effect. The inventors also believe that this effect is further enhanced by using different configurations for the plurality of pickets on the respective pairs of radial arms 141 and 142.

There is no uniform average shear in the intervals 144 and 146 between the pickets 143 (due to the reduced picket length) or the pickets 145 (due to the evenly spaced intervals 146). However, the overall average shear from a sum of the average shears from the intervals of the pickets 143 of the longer radial arms 141 and the pickets 145 of the shorter radial arms 142 is substantially uniform or the same, because the variances in the average shear in the intervals 146 between the pickets 145 are counterbalanced by the variances in the average shear in the intervals 144 between the pickets 143.

In this embodiment, it is also contemplated that either the longer radial arms 141 or the shorter radial arms 142 could be configured to be removed or added into the disturbance zone 43, thus controlling the shape of the shearing device 140 in accordance with the methods 27 and 31 of FIGS. 2B and 3, respectively.

Referring to FIG. 15, the shearing device 150 is separately mounted to a concentric drive shaft 151 for substantially vertical motion 152 parallel to a central axis 153 of the tank and a central drive shaft 154. The shearing device 150 comprises a substantially circular plate 155 arranged substantially horizontally with respect to the tank 1 and having a series of holes or apertures 156 that are equally spaced from each other. The concentric drive shaft 151 reciprocates the plate 155 substantially vertically with respect to the pulp bed 2 and the tank 1, as indicated by arrow 152. The length of the stroke of the shearing device 150 controls the depth of the disturbance zone, and thus provides a way of predetermining and/or adjusting the disturbance zone depth to implement the methods 27 and 31 of FIGS. 2B and 3, respectively. The inventors also believe that this reciprocating vertical motion 152 results in a substantially uniform shear, and thus a substantially uniform cumulative shear, being applied to pulp passing through the region 43 in a similar manner to that described in relation to the shearing devices, although using a vertical component of movement for the shearing device 150 rather than rotation around an axis of rotation 49 coincident with the central drive shaft 154. As the holes 156 are substantially equal in size the applied shear is substantially uniform, thus resulting in a substantially uniform cumulative shear and a substantially uniform number of shear events. Preferably, the amount of vertical movement is about 500 mm upwardly and downwardly, or in total around 1 m.

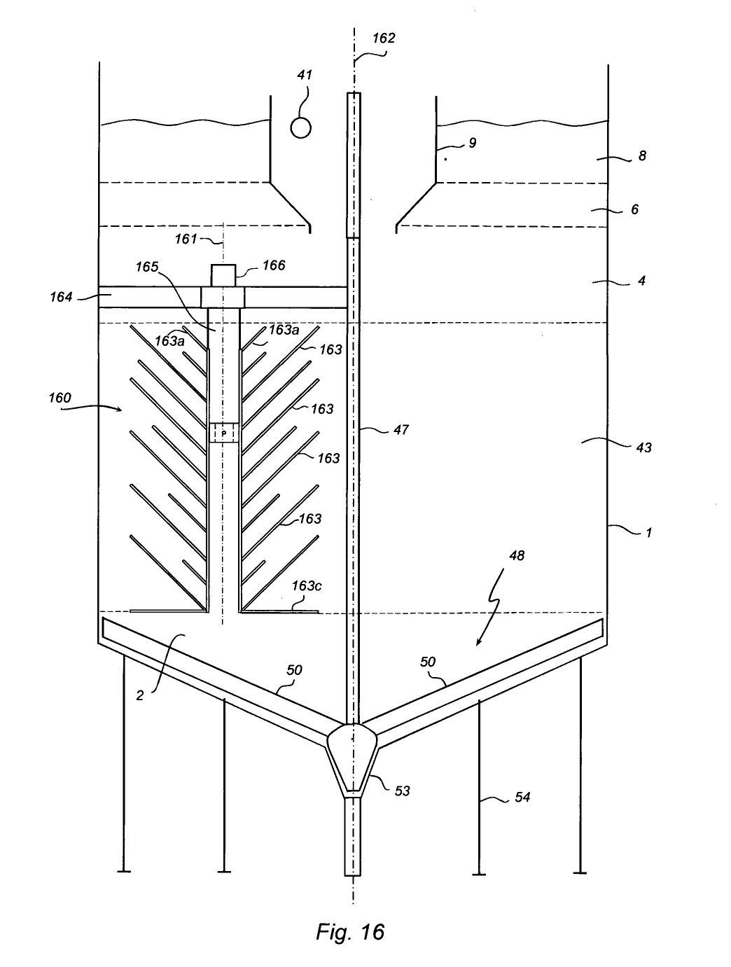

Referring now to FIG. 16, the shearing device 160 of FIG. 8 is mounted for rotation about an axis 161 that is eccentric or offset with respect to a central axis 162 of the tank 1. The shearing device 160 is structurally similar to the shearing device 42 of FIG. 4, having a tree-like array of angled pickets 163 and thus operates in the substantially same manner as the shearing device 42. The shearing device 160 is connected to a central drive shaft 47 axially aligned with the central axis 162 of the tank 1 by way of a support 164 and associated drive shaft 165. The central drive shaft 47 rotationally drives the support 164 to rotate the axis of rotation 161 about the central axis 162. Thus, there are two components of rotational movement, the rotation of the shearing device 160 about its axis of rotation 161 and the rotation of the axis of rotation 161 itself about the central axis 162, akin to planetary motion. That is, the motion of a spinning planet revolving in orbit around a central axis defined by the sun.

The central drive shaft 47 drives rotation of the support 164 via an epicyclic gear assembly (not shown). Alternatively, the one or more peripheral drives (not shown) may rotationally drive the support 164 via an epicyclic gear assembly. This enables multiple drives to be used that can supply an increased amount of torque to the shearing device 160, with the rotational speed of the drive shaft 165 being a function of the drive speed of the input drives and the ratios of the drive gears in the epicyclic gear assembly.

In this embodiment, an independent drive mechanism 166 drives rotation of the shearing device 160 about the axis of rotation 161, while the central drive shaft 47 drives rotation of the rake assembly 48. Consequently, the shearing device 160 can be rotated at a different speed to the rake assembly 48, or even counter-rotated in the opposite direction, to inhibit, prevent or minimise the formation of donuts in the pulp bed 2.

By splitting the rotation of the shearing device 160 from the rotation of the rake assembly 48, this embodiment also advantageously permits the provision of low torque drives for both the shearing device 160 (due to the small mechanism diameter) and the central drive shaft 47 (due to the reduced area of the central drive mechanism, as it does not have to drive the shearing device 160). However, the embodiment can be equally applied to larger tanks requiring larger torques.

In operation, the central drive shaft 47 rotates the support 164 around the thickening tank 1 about the central axis 162 clockwise or counter-clockwise, thus rotating the eccentric axis 161 about the central axis 49. Simultaneously, the drive mechanism 166 drives the shearing device 160 separately so as to rotate the pickets 163 around the eccentric axis 161 clockwise or counter-clockwise to shear the pulp aggregates or particles, so as to apply a substantially uniform cumulative shear to the pulp passing through disturbance zone 43 of the pulp bed 2.

A particular advantage of this embodiment is that the dual rotation of the shearing device 160 provides a more complex fluid motion than previous embodiments, thus increasing the difficulty for any significant volume of pulp solids in the thickened pulp bed 2 to form a stable agglomerated mass that would rotate with the shearing device 160 and/or rake assembly 48 and thus cause donutting.

It will also be appreciated by those skilled in the art that the drives and support mechanisms can be located anywhere in or on the separation device, as desired. For example, the support can be disposed adjacent the top or bottom of the tank, or anywhere in between. Similarly, the peripheral drive or drives can be located adjacent the top or bottom of the tank, within the tank perimeter, at its outer perimeter adjacent the tank sidewall or any combinations of these locations.

In other embodiments, the shearing devices illustrated in FIGS. 4, and 8 to 14 are mounted for rotation independently of the central drive shaft 47. This decoupling of the rotation of the shearing device 42, 80, 85, 88, 90, 95, 100, 110, 120, 130 and 140 and the rake assembly 48 enables the use of different rotational speeds for the shearing device and the rake assembly, respectively. This results in donut minimisation or prevention within the tank 1, as discussed above. Moreover, the shearing device 42, 80, 85, 88, 90, 95, 100, 110, 120, 130 and 140 can be rotated in the opposite direction to the rake assembly 48, further enhancing donut minimisation or prevention. In these embodiments, the shearing device is mounted to a concentric drive shaft, similar to the one illustrated in FIG. 15, although the concentric drive shaft in this case would be mounted for rotation about the central axis 49 of the tank 1, rather than providing substantially vertically reciprocating motion.

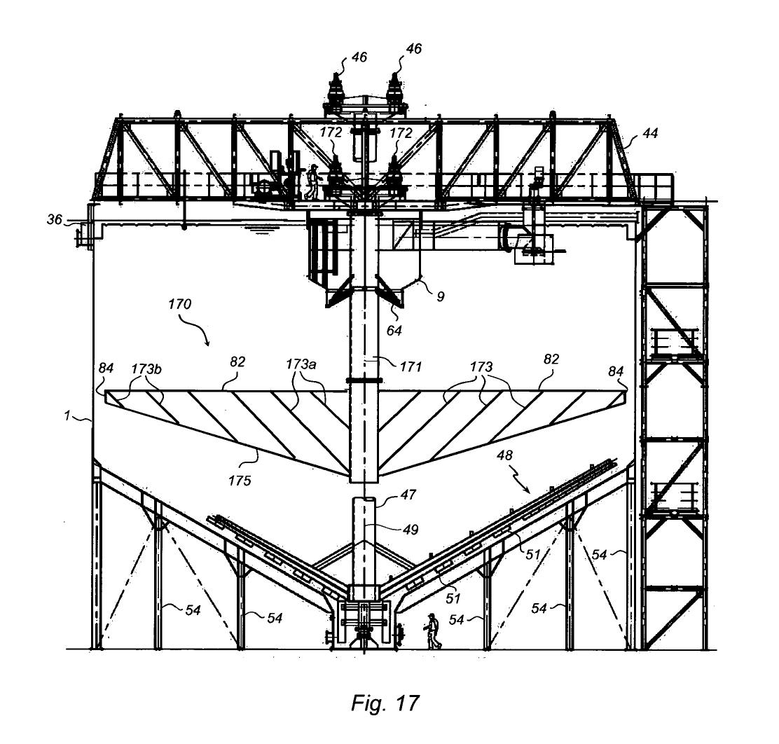

One such embodiment is illustrated in FIG. 17, where corresponding features have been given the same reference numerals. In this embodiment, the shearing device 170 is mounted to an outer concentric drive shaft 171 and is driven by its own pair of pinion drives 172 separate to a pair of pinion drives 46 that rotate the rake assembly 48 via inner drive shaft 47. In addition, the shearing device 170 has two radial arms 82 with pickets 173 extending from the concentric drive shaft 171 to the outer edges 84 and equispaced with respect to each other. The pickets 173 are supported by a border 175, which defines the shape of the radial arms 82. The pickets 173 are angled at approximately 45° to the vertical and connected to the border 175. In this embodiment, the shearing device 170 provides a substantially uniform cumulative shear to pulp exiting the region 43 due to the lengths of the pickets 173 progressively reducing from the axis of rotation 49 to the outer edges 84 and the angled arrangement of the pickets. However, the shearing device 170 does not provide uniform average shear in the intervals between the pickets 173, since they are equispaced with respect to each other. That is, the increased shear force applied by the outer pickets 173b is compensated by an adjustment to the length of the pickets 173. While this results in the average shear varying between the pickets 173, the cumulative shear from this picket configuration is substantially uniform, since the reduced picket length counterbalances the increased shear at the outer edges 84. Accordingly, the shearing device 170 provides an optimal shear to the pulp in accordance with the methods 20, 27 and 31 of the invention.

Yet other embodiments use the configuration of the shearing devices of FIGS. 4, 9 to 15 and 17 mounted for rotation about a parallel, eccentric or offset axis to the central axis 49 of the tank 1 in the manner as illustrated in FIG. 16.

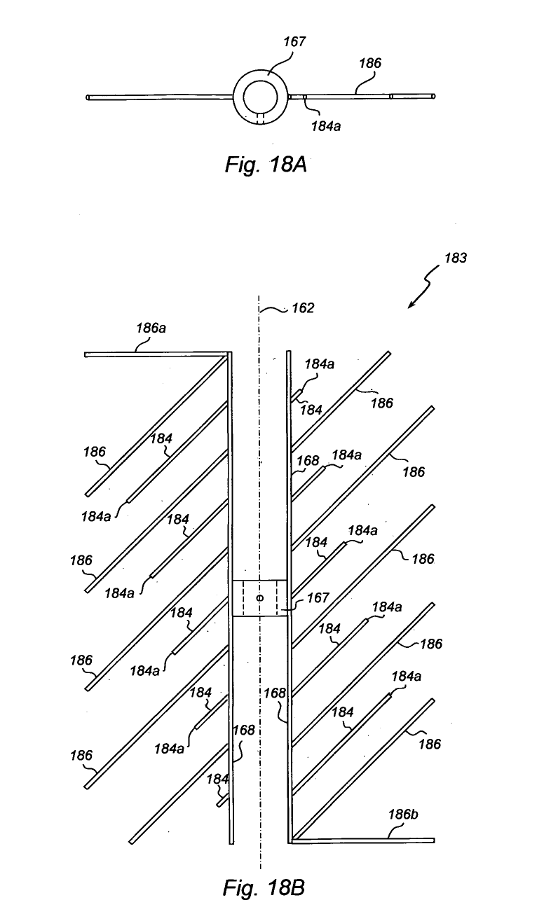

Additional shearing device configurations for the separation device 160 are illustrated and briefly described in relation to FIGS. 18A to 22B, where corresponding features have been given the same reference numerals. As these shearing devices substantially operate in the same manner as the operation of the shearing device 161, a detailed description of their operation will not be repeated.

Referring to FIGS. 18A and 18B, the shearing device 183 is arranged so that progressively shorter angled pickets 184 on either side of the stems 168 have their respective tips 184a pointing outwardly and alternate between relatively longer angled pickets 186. Again, the shorter pickets 184 provide an increased number of varied shear events closer towards the rotational axis 162. Both sets of “primary” pickets 186 and “secondary” pickets 184 are asymmetrical with respect to the axis of rotation 162. Two of the pickets 186a and 186b extend substantially horizontally at the top and bottom portions of the shearing device 183, respectively. The primary pickets 186 also define a substantially rectangular cross-section approximating the radial cross-section of the tank.

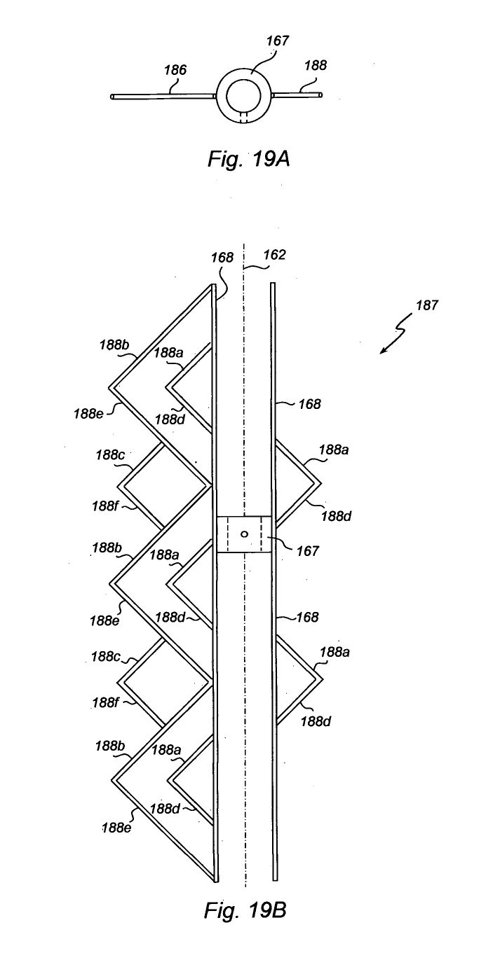

Referring to FIGS. 19A and 19B, the shearing device 187 comprises a plurality of angled pickets 188 arranged in a zigzag-like fashion to define a tiered saw-tooth like profile. Pickets 188a, 188b and 188c extend downwardly relative to the stems 168, whereas the pickets 188d, 188e and 188f extend upwardly relative to the stems. The downwardly extending pickets 188a, 188b and 188c are connected to the upwardly extending pickets 188d, 188e and 188f, respectively, to define an asymmetric picket configuration. One side of the shearing device 187 has two “tiers” of teeth, comprising an inner tier of pickets 188a and 188d and an outer tier of pickets 188b and 188e, with the pickets 188c and 188f supplementing the outer tier. The other side of the shearing device has a single inner tier of pickets 188a and 188d. This picket configuration provides an increased number of varied shear events closer towards the rotational axis 162.

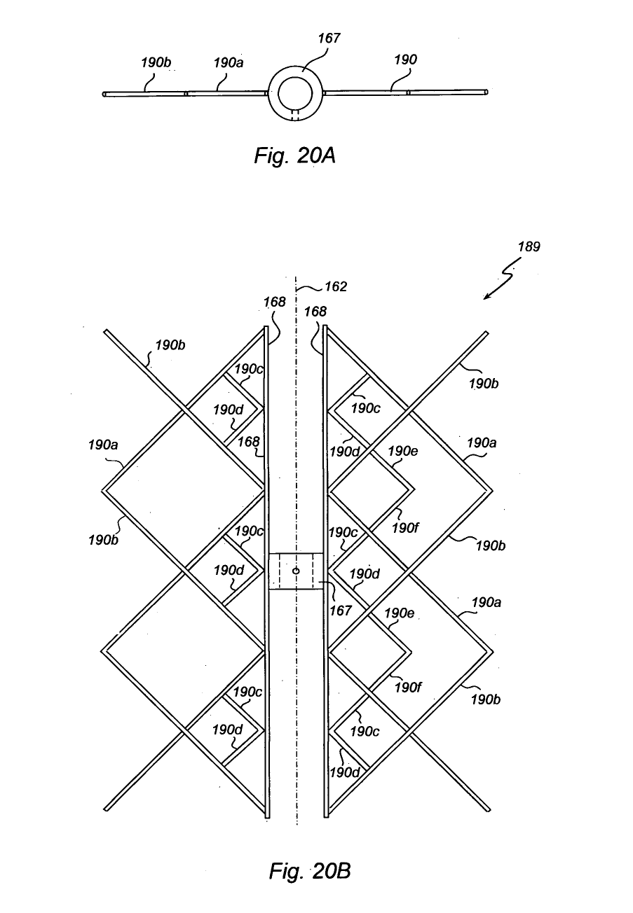

Referring to FIGS. 20A and 20B, the shearing device 189 has a plurality of pickets 190 that form an asymmetric mesh-like structure, similar to the mesh 49 illustrated in the embodiment of the invention of FIG. 13. Pickets 190a, 190d and 190e extend downwardly with respect to the stems 168, whereas the pickets 190b, 190c and 190f extend upwardly with respect to the stems. The pickets 190 are arranged so that a downwardly extending picket 190a crosses an upwardly extending picket 190b to define an “X”-shape, with each “X” being joined together to define a general diamond-like mesh appearance. Secondary upwardly extending pickets 190c and downwardly extending pickets 190d are disposed adjacent the stems 168, with the upwardly extending pickets 190c connected to the upwardly extending pickets 190d. An additional set of pickets 190e and 190f are disposed between two. X-shapes to provide an asymmetric configuration. The pickets 190 are angled at approximately 45° to the vertical plane. Again, this picket configuration provides an increased number of varied shear events closer towards the rotational axis 162.

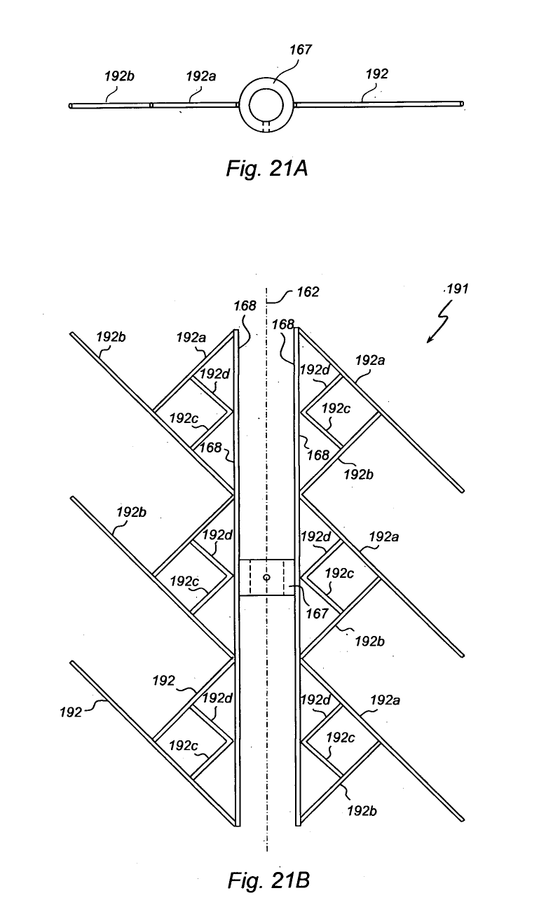

Referring to FIGS. 21A and 21B, the shearing device 191 has a plurality of pickets 192 that are arranged asymmetrically about the axis of rotation 162. The pickets 192a extend downwardly while pickets 192b extend upwardly relative to their respective stems 168, the downwardly extending pickets 192a being connected to upwardly extending pickets 192b. Each of the pickets 192 is angled with respect to the vertical plane at approximately 45°. There is an inner set of secondary pickets adjacent the stems 168, with downwardly extending pickets 192c connected to upwardly extending pickets 192d. This picket configuration provides an increased number of varied shear events closer towards the rotational axis 162.

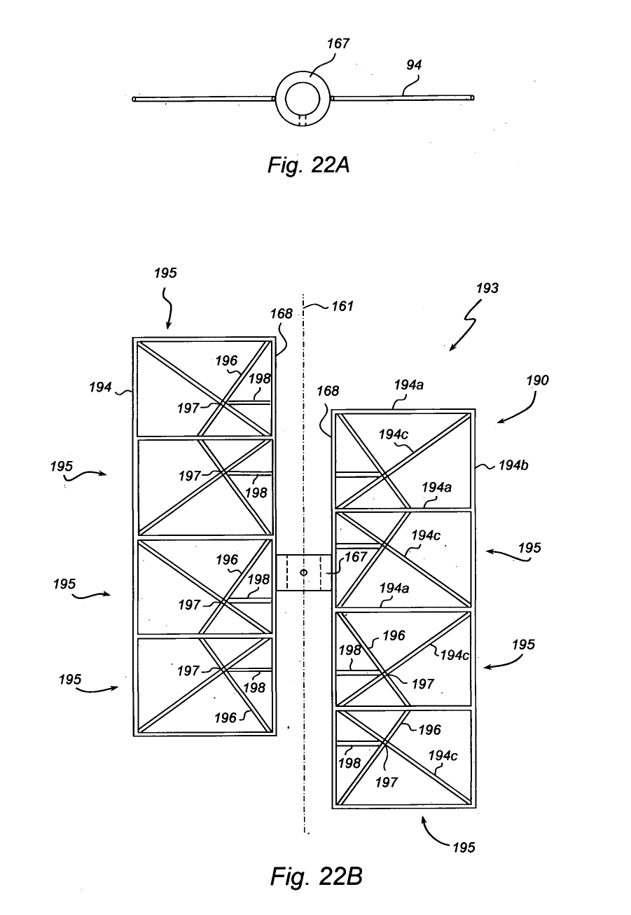

Referring to FIGS. 22A and 22B, the shearing device 193 has a plurality of pickets 194 arranged to define vertically offset box-like structures 195, with horizontal pickets 194a and vertical pickets 194b defining the horizontal and vertical sides of the boxes 195, respectively. In addition, diagonally extending pickets 194c connect one pair of corners of each box 195 in a zigzag-like fashion to define a saw-tooth-like path, the pickets 194c being angled at approximately 45° to the vertical plane. Angled pickets 196 intersect the pickets 194c so that the point of intersection 197 is offset to the centre of each box 195 and are disposed in a similar zigzag-like fashion to define a saw-tooth-like path. Furthermore, horizontal pickets 198 are provided that connect the respective points of intersection 197 to the stems 168. This picket configuration provides an increased number of varied shear events closer towards the rotational axis 162.

In other embodiments, the shearing devices illustrated in FIGS. 2A, 2B and 8A to 15B are mounted for rotation about a parallel, eccentric or offset axis to the central axis 49 of the tank 1 in the manner illustrated in FIG. 16. Likewise, the configurations of the shearing devices illustrated in FIGS. 16 to 22B may also be suitably modified for rotation about the central axis 49 using a concentric drive shaft in the manner illustrated in FIGS. 2 to 14. Furthermore, the shearing devices of FIGS. 2, 8 to 14 and 16 to 22B may also be suitably adapted for substantially vertically reciprocating motion parallel to, rather than rotation about, the central axis 49. While the embodiments have been described with reference to the rake assembly 48 being rotated about a central axis of the tank, it will be appreciated that the rotational axis of the rake assembly may also be parallel, offset or eccentric to the central axis of the tank.

In addition, the preferred embodiments in FIGS. 4, 8 to 11 and 16 to 22B have been described and illustrated with pickets angled with respect to a vertical plane that is at right angles to the radial arm. However, it will be appreciated that the pickets can be angled with respect to other vertical planes, such as a vertical plane parallel to or coplanar with the radial arms, as illustrated in FIG. 14. In other embodiments, the pickets may be only angled with respect to the vertical plane parallel to or coplanar with the radial arms.

Moreover, whilst the preferred embodiments of the invention have been described as employing shearing elements in the form of linear pickets or rods, it would be appreciated by one skilled in the art that other configurations for the shearing elements can be used, such as V-shaped angled rods, half or semi-circular tubes or other shearing elements having different polygonal cross-sections. In particular, the pickets themselves can be altered in shape to produce the desired shear profile. For example, a non-linear picket can be used, such as a spiral or helical shape.

In addition, the shearing devices have been described and illustrated with pickets angled with respect to a vertical plane that is at right angles to the radial arm. However, it will be appreciated that the pickets can be angled with respect to other vertical planes, such as a vertical plane parallel to or coplanar with the radial arms so that the pickets have an angle of incidence with respect to the direction of rotation of the shearing device. This orientation of the pickets enables relatively longer pickets to be used in the shearing device compared to the length of the pickets in other configurations.

While the preferred embodiments have been described and illustrated in a manner to produce an optimal disturbance, preferably shear, substantially across the disturbance zone 16, where the disturbance zone includes substantially the entire upper region, one skilled in the art will appreciate that similar advantageous effects could be obtained by applying the optimal disturbance or applying the optimal shear across a disturbance zone that is a proportion of the upper region. This proportion of the upper region may include a partial cross-sectional area or even a partial volume of the tank. For example, individual pickets can be removed from the radial arms so that the optimal shear occurs at a series of intervals, or mostly only towards the outer perimeter of the tank 1 or towards the inner radial area of the tank adjacent or close to the axis of rotation. In this case, the disturbance zone 16 is effectively segmented across the cross-section of the tank 1. Alternatively, it could be viewed as providing multiple disturbance zones separated by quiescent areas in the upper region. On either interpretation, the optimal disturbance caused or shear applied substantially uniformly across a disturbance zone can occupy at least 10% of the volume of the upper region up to the entire upper region (100%). As the amount of pulp approximates to the cross-sectional area of the upper region, then the disturbance or shear is applied to at least 10% to 100% of the networked pulp in the upper region within a predetermined period of time corresponding to the passage of the networked pulp through the disturbance zone 16.

The inventors recognise that there may be situations where it is desired that not all of the networked pulp is subjected to a disturbance or shear, and in such cases it is preferred that at least 30% of the pulp passing through the upper region (ie. the disturbance zone being 30% of the upper region), more preferably at least 50% of the pulp passing through the upper region (ie. the disturbance zone being 50% of the upper region) or even more preferably at least 70% of the pulp passing through the upper region (ie. the disturbance zone being 70% of the upper region) are disrupted in the disturbance zone 16. However, the inventors believe that to maximise the efficiency of the shearing device and thus improve thickener performance, it is particularly preferred that at least 75% to 100% of the pulp passing through the upper region is subjected to the optimal disturbance or shear, more preferably 80%, even more preferably 90% and even yet more preferably 95% to 100% of the pulp passing through the upper region (the disturbance zone being 95% to 100% of the upper region) in order to obtain significant advantages in the use of the invention. This applies irrespective whether substantially uniform cumulative shear, substantially uniform average shear or a substantially uniform number of shear events, or any combination thereof, is applied in the disturbance zone. It also extends to the disturbance being caused by another mechanism other than the application of shear substantially uniformly across the disturbance zone.

It will be appreciated by one skilled in the art that in the invention controlling one or more disturbance parameters (or shearing parameters) with respect to the flux of the feed material (suspension) and/or one or more operational parameters results in the application of an optimal to the networked pulp in the disturbance zone. This ensures that the optimal disturbance shear is applied to disrupt the networked pulp without applying too little or excessive shear. That is, the invention avoids the need to conduct trial and error to determine the correct amount of disturbance or shear necessary to release liquid without excessively disrupting the networked pulp that would prevent efficient settling in the tank. The invention also avoids the risk of applying insufficient disturbance or shear that would be ineffective to achieve the desired disruption of networked pulp and release of liquid. Thus, an optimal amount of trapped liquid is released that can escape upwardly to the clarified zone of liquor. As the pulp below the disturbance zone has a higher relative density, it has an increased packing density, enabling quicker settling and thus more pulp to be compacted in the pulp bed below the disturbance zone. As a consequence, the underflow density of the pulp bed is maximised and the maximum amount of dilute liquor can be recovered through the overflow launder. This effect is particularly advantageous where the disturbance, preferably in the form of shear, is in a disturbance zone in the upper region of the pulp bed. As a consequence, the invention achieves significant efficiencies in performance and the amount of settled material that is obtained. Another advantage is that the turbulence created in the disturbance zone inhibits or prevents the formation of donuts in the pulp bed or networked pulp layer. In all these respects, the invention represents a practical and commercially significant improvement over the prior art.

Although the invention has been described with reference to specific examples, it will be appreciated by those skilled in the art that the invention may be embodied in many other forms.

1-111. (canceled)

112. A method for controlling a disturbance to networked pulp in a separation device comprising a tank, the method comprising the steps of:
introducing a feed material into the tank at a flux;
allowing pulp to settle out of the feed material and form into a networked layer of pulp;
submerging a shearing device at least partially into a region of the tank to apply shear to the networked pulp in a disturbance zone of the networked layer; and
controlling one or more shearing parameters with respect to the flux and/or one or more operational parameters to controllably apply an optimal shear to the networked pulp in the disturbance zone.

113. The method of claim 112, further comprising the step of adjusting one or more of the shearing parameters in response to changes in the flux.

114. The method of claim 112, further comprising the step of adjusting one or more of the shearing parameters in response to changes in one or more of the operational parameters.

115. The method of claim 112, wherein the shearing parameters are selected from the group consisting of the speed of the shearing device, the shape of the shearing device and the depth of the disturbance zone.

116. The method of claim 115, further comprising the step of moving the shearing device at a speed with respect to the flux and/or one or more operational parameters.

117. The method of claim 116, wherein the shearing device speed is a linear speed of the shearing device.

118. The method of claim 116, further comprising the step of rotating the shearing device.

119. The method of claim 118, wherein the shearing device speed is the rotational speed of the shearing device

120. The method of claim 112, further comprising the step of controlling the submersion of the shearing device to control the disturbance zone depth with respect to the flux and/or one or more operational parameters.

121. The method of claim 120, wherein the level of the feed material in the tank is adjusted to control the submersion of the shearing device.

122. The method of claim 116, further comprising the step of controlling the shearing device shape.

123. The method of claim 112, wherein the one or more of the shearing parameters are controlled according to the relationship:
S₁=f₁(h).f₂(f).f₃(ρ).f₄(λ).f₅(y)
where
S₁ is the optimal shear;
f₁(h) is the disturbance zone height or depth function;
f₂(f) is the flux function;
f₃(ρ) is the operational parameter function;
f₄(λ) is the shear factor function; and
f₅(y) is the shearing device speed function.

124. The method of claim 123, wherein the speed of the shearing device, the disturbance zone depth and the flux are constant, and the one or more of shearing parameters are controlled according to the relationship:
$${S}_{1} = \frac{λ \times y \times h \times {f}_{3} ( ρ )}{f}$$
where
S₁ is the optimal shear;
λ is the shear factor;
y is the speed of the shearing device;
h is the height or depth of the disturbance zone;
f is the flux; and
f₃(ρ) is the operational parameter function.

125. The method of claim 124, wherein the operational parameters are constant, and the one or more of shearing parameters are controlled according to the relationship:
$${S}_{1} = \frac{λ \times y \times h \times {k}_{ρ}}{f}$$
where
S₁ is the optimal shear;
λ is the shear factor;
y is the speed of the shearing device;
h is the height or depth of the disturbance zone;
f is the flux; and
k_{ρ} is a constant representing the operational parameters.

126. The method of claim 112, wherein the shearing device speed is kept proportional to the flux.

127. The method of claim 112, wherein the depth of the disturbance zone is kept proportional to the flux.

128. The method of claim 112, wherein the shear factor is kept proportional to the flux, where the shear factor is a function of the shearing device geometry and speed.

129. The method of claim 112, further comprising the step of monitoring the flux of the feed material.

130. The method of claim 112, further comprising the step of monitoring the flux of the feed material.
The method of any one of the preceding claims, wherein the operational parameters are selected from the group consisting of the pulp composition, the pulp particle size, the pulp flow velocity in the tank, the pulp yield stress, the pulp viscosity, the underflow specific gravity, the underflow weight per weight percentage and the rate at which flocculant is added to the feed material.

131. A separation device for separating pulp from a feed material, the separation device comprising:
a tank for receiving the feed material at a flux;
a shearing device submersible at least partially into a region of the tank to apply shear to networked pulp in a disturbance zone of a networked layer that is formed from pulp settling out of the feed material; and
means for controlling one or more shearing parameters with respect to the flux and/or one or more operational parameters to controllably apply an optimal shear to the networked pulp in the disturbance zone.
